(19) United States
(12) Patent Application Publication
(10) Pub. No.: US 2017/0076391 A1
(43) Pub. Date: Mar. 16, 2017

(54) SYSTEM OF PERPETUAL GIVING

(71) Applicant: SYED KAMRAN HASAN, Great Falls, VA (US)

(72) Inventor: SYED KAMRAN HASAN, Great Falls, VA (US)

(21) Appl. No.: 15/264,744

(22) Filed: Sep. 14, 2016

Related U.S. Application Data
(60) Provisional application No. 62/220,914, filed on Sep. 18, 2015.
(60) Provisional application No. 62/218,459, filed on Sep. 14, 2015.
(60) Provisional application No. 62/323,657, filed on Apr. 16, 2016.

(51) Int. Cl. G06Q 40/06; G06Q 40/02

(52) U.S. Cl. CPC G06Q 40/06; G06Q 40/02

(57) ABSTRACT

A system of perpetual giving comprises donor entities, endowment fund entities, business entities, a control board, an investment allocator and a profit allocator. The donor entities invest to the endowment fund entities and the endowment fund entities return profit to the donor entities. Tax write-off is applied between tax paid by the donor entities and investment by the donor entities to the endowment fund entities. The endowment fund entities invest to the business entities and the business entities return profit to the endowment fund entities. The investment allocator makes investment recommendation to the control board. The control board provides investment preferences to the investment allocator. The profit allocator makes recommendation regarding reinvestment fund for the business entities and delegated fund for the control board. Each allocator comprises a pattern matching module and a static variables module. The system uses creativity module and CTMP module.

### CROSS REFERENCE TO RELATED APPLICATIONS

The present application claims priority on Provisional Application No. 62/220,914 filed on 18 Sep. 2015, entitled Cyber Security Suite; Provisional Application No. 62/218,459 filed on 14 Sep. 2015, entitled System & Method for Perpetual Giving; and Provisional Application No. 62/323,657 filed on 16 Apr. 2016, entitled Critical Thinking Memory & Perception (CTMP); the disclosures of which are incorporated by reference as if they are set forth herein.

### FIELD OF THE INVENTION

The present invention is related to a system of optimizing investment by computerized analysis. More specifically, the invention is related to providing an effective system for donation by computerized method for analyzing factors of business including tax code and producing solutions for profit activity that complies the tax code.

### BACKGROUND OF THE INVENTION

Analyzing tax regulations is a strenuous and complicate task. Often profits made from operating business is substantially adjusted by application of tax laws that regulate businesses from various perspectives. A solution adopting high-level artificial intelligence for analyzing tax regulations together with usual business parameters and producing effective investment strategy has long been in need.

### BRIEF SUMMARY OF THE INVENTION

The present invention provides a system of perpetual giving. The system has a memory that stores programmed instructions, a processor that is coupled to the memory and executes the programmed instructions and at least one database. The programmed instructions are related to the following components: a) one or more donor entities; b) one or more endowment fund entities, wherein the donor entities invest to the endowment fund entities and the endowment fund entities return profit to the donor entities, wherein tax write-off is applied between tax paid by the donor entities and investment by the donor entities to the endowment fund entities; c) one or more business entities, wherein the endowment fund entities invest to the business entities and the business entities return profit to the endowment fund entities; d) a control board; and e) an investment allocator that makes investment recommendation to the control board, wherein the control board provides investment preferences to the investment allocator. The investment allocator comprises a pattern matching module and a static variables module. The donor entity, the endowment fund entity, the business entity and the control board are computer renderings that correspond to corporations or institutions in society. The computer rendered entities may communicate to and from human beings that work for the corporations, etc. via input devices and output devices and over the communication networks such as the Internet.

The system further comprises a profit allocator that makes recommendation regarding reinvestment fund for the business entities and delegated fund for the control board. The profit allocator comprises a pattern matching module and a static variables module.

Data for market performance and profit history are delivered for the pattern matching module of the investment allocator. Data for the business entity profit composition is delivered to the profit allocator.

In the pattern matching module, profit and/or investment allocation decisions are stored, and a creativity module uses the stored decision, the profit history, the market performance, the static variables in the static variables module, or static criteria provided by the control board to create new variations of allocation decisions.

The system further comprises a portfolio designer that designs an investment portfolio. In the portfolio designer, investment amount, charitable causes and desired risk, long term allocation trend from the stored allocation decisions, and/or profit trend from a profit margin makeup module are input to a creativity module.

The system further comprises a tax code interpreter that comprises a find overlap module, which performs calculated overlap search between two or more tax codes; and a generic tax unit that stores tax law information. The generic tax unit comprises an initial definition update module and a preliminary conversion module that converts tax law information into a raw structure that comprises a dependency tree and unit definitions. The dependency tree contains links of object dependencies, wherein the unit definitions contains names, descriptions and definitions of tax related objects.

The generic tax unit further comprises a parallelized computer processing system that receives the raw structure as part of a definition update and performs scalable and parallel data mining process to calculate data sets to compose a derived structure.

The derived structure comprises a derived tree that contains data that have been implied from the originals of the raw structure, a unit definitions that contain labels associated with the objects referenced by the derived tree, derived rules that are inherited by the derived tree, wherein the derived structure deduces points of interest with generic popularity algorithm.

In response to simple information queries, the raw structure of a first tax code and the raw structure of a second code are compared. In response to complex information queries, the derived structure of the first tax code and the derived structure of the second tax code are compared. A focus points analysis synchronizes the points of interests of the first tax code and the points of interests of the second tax code. Results from the focus points analysis are sent to the derived trees of the first tax code and the second tax code. Information from the derived trees are matched with their respective definitions from the unit definitions.

The creativity module references two or more prior allocation decisions. Each of the allocation decisions comprises a market context, an investor context, and a final result. The allocation decisions are provided to an intelligent selector, which performs comparison and deduction of two objects from each of the allocation decisions and pushes a hybrid form for output. A criteria matching module references input criteria provided from the pattern matching modules and chooses the hybrid form from the intelligent selector, which suits the market variables.

The prior allocation decisions comprise an average model of a financial allocation decision derived from a prior allocation decisions database and a new information released by the allocators. The intelligent selector merges them into the hybrid form. A mode defines type of algorithm that the creativity module is being used in. Amount of overlapping information is filtered through according to a ratio set by the static criteria, which include ranking prioritizations, desired ratios of data, and data to direct merging which is dependent on what Mode is selected. A raw comparison is performed on the prior allocation decisions dependent on the static criteria.

When both data sets compete to define a feature at the same place in the form, a prioritization process occurs to produce a form with merged traits based on the static criteria and the mode.

An input module receives result by the pattern matching and the allocation decision. A reason processing module compares attributes of the received inputs and derives rules. The reason processing module comprises a rule processing module that uses the derived rules as reference point to determine the scope of perceptions for a given problem. A critical rule scope extender receives the known scope of perceptions and upgrades them to include critical thinking scope of perceptions. The derived rules are corrected by using the critical thinking scope of perceptions.

A memory web scans logs for fulfillable rules. Applicable and fulfillable rules are executed to produce override decisions. A rule execution module executes rules that have been confirmed as present and fulfilled to produce critical thinking decisions. A critical decision output module produces final logic by comparing conclusions reached by a perception observer emulator and the rule execution module.

A logs module comprises raw information that is used to make a critical decision without influence of the input. An applied angles of perception module comprises angles of perception that have been applied and utilized by the input algorithm. An automated perception discovery mechanism leverages the creativity module to increase the scope of perception.

A self-critical knowledge density module estimates scope and type of potential unknown knowledge that is beyond the reach of the reportable logs. The perception observer emulator produces emulation of observer, and tests and/or compares all potential points of perception with variations of observer emulations. Input for the perception observer emulator comprises all the potential points of perception and enhanced data logs and output for the perception observer emulator comprises decision produced from the enhanced data logs and according to the most relevant observer with mixture of selected perceptions. The CVF derived from the data enhanced logs is used as search criteria for a perception storage. An implication derivation module derives angles of perception of data that are implicated from known angles of perceptions. A metric combination module separates angles of perception into categories of metrics. A metric conversion module reverses individual metrics back into whole angles of perception. A metric expansion module categorically stores the metrics of angles of perception in individual databases.

A critical rule scope extender leverages known perceptions to expand critical thinking scope of rulesets. A perception matching module forms CVF from the perception received from rule syntax derivation. A memory recognition module forms a chaotic field from input data and performs field scanning to recognize known concepts. A memory concept indexing module individually optimizes the whole concepts into indexes. A rule fulfillment parser receives the individual parts of the rule with a tag of recognition, logically deduces which rules have been recognized in the chaotic field to merit rule execution. A rule syntax format separation module separates and organizes correct rules by type. A rule syntax derivation module converts logical rules to metric based perceptions. A rule syntax generation module receives confirmed perceptions and engages with the perception's internal metric makeup.

A final logic module logic receives intelligent information from an intuitive decision and a thinking decision. A direct decision comparison module compares both decisions from the intuitive decision and the thinking decision to check for corroboration. The intuitive decision engages in critical thinking via leveraging perceptions. The thinking decision engages in critical thinking via leveraging rules. A critical rule scope extender extends the scope of comprehension of the rulesets by leveraging previously unconsidered angles of perception. A chaotic field parsing module combines the format of the logs into a single scannable unit known as the chaotic field. Extra rules are produced from a memory recognition module to supplement the already established correct rules.

In a perception matching module, concerning metric statistics, statistical information is provided from a perception storage. The statistics define the popularity trends of metrics, internal metric relationships, and metric growth rate. An error management module parses syntax and/or logical errors stemming from any of the individual metrics. A node comparison module receives the node makeup of two or more CVFs. Each node of the CVF represents the degree of magnitude of a property. A similarity comparison is performed on an individual node basis, and the aggregate variance is calculated. A raw perceptions intuitive thinking module processes the perceptions according to an analog format. A raw rules logical thinking module processes rules according to a digital format. Analog format perceptions pertaining to the financial allocation decision are stored in gradients on a smooth curve without steps. Digital format raw rules pertaining to the financial allocation decision are stored in steps with no grey area.

The present invention also provides A method of perpetual giving performed in a system having a memory that stores programmed instructions, a processor that is coupled to the memory and executes the programmed instructions and at least one database. The method comprises steps of (a) investing to one or more endowment fund entities by one or more donor entities; (b) returning profit to the donor entities by the endowment fund entities, wherein tax write-off is applied between tax paid by the donor entities and investment by the donor entities to the endowment fund entities; (c) investing to one or more business entities by the endowment fund entities; and (d) returning profit to the endowment fund entities by the business entities. An investment allocator makes investment recommendation to a control board. The control board provides investment preferences to the investment allocator. A profit allocator makes recommendation regarding reinvestment fund for the business entities and delegated fund for the control board. Each of the allocators include a creativity module and a CTMP module.

### BRIEF DESCRIPTION OF THE DRAWINGS

The invention will be more fully understood by reference to the detailed description in conjunction with the following figures, wherein:

FIG. 1 is a block diagram showing the task flow of a perpetual giving system according to the present invention;

FIG. 2 is a schematic diagram showing the investment and return flows between the entities of FIG. 1;

FIG. 3 is a schematic diagram showing that modules to handle tax regulations;

FIG. 4 is a schematic diagram showing controls by a board of directors;

FIG. 5 and FIG. 7 are schematic diagrams showing a profit allocator and an investment allocator;

FIG. 6 is a schematic diagram showing a profit margin makeup algorithm;

FIG. 8 is a schematic diagram showing a pattern matching algorithm for allocation decisions;

FIG. 9 is a schematic diagram showing a portfolio designer algorithm;

FIG. 10 is a schematic diagram showing a tax code interpreter algorithm;

FIG. 11 is a schematic diagram showing a raw structure and a derived structure of a generic tax unit;

FIG. 12 is a schematic diagram showing tax code interpreter algorithm;

FIG. 13 is a schematic diagram showing how a creativity module is used for allocation decisions;

FIG. 14 is a schematic diagram showing the creativity module;

FIG. 15 is a schematic diagram showing an intelligent selector sub-module of the creativity module;

FIG. 16 and FIG. 17 are schematic diagrams showing how merging is made by a prioritization process in the creativity module;

FIG. 18 is a schematic diagram showing sub-modules using angles of perceptions by CTMP;

FIG. 19 is a schematic diagram showing sub-modules related to different levels of angles of perceptions;

FIG. 20 is a schematic diagram showing a perception observer emulator;

FIG. 21 is a schematic diagram showing sub-modules related to metrics and angles of perception;

FIG. 22 is a schematic diagram showing sub-modules related to analysis of rules;

FIG. 23 is a schematic diagram showing the flow of processing intelligent information in CTMP;

FIG. 24 is a schematic diagram showing input and output for CTMP;

FIG. 25 is a schematic diagram showing a selected pattern matching algorithm;

FIG. 26 are schematic diagrams showing a critical thinking algorithm performed by CTMP via perceptions and rules;

FIG. 27 is a schematic diagram showing how correct rules are produced by CTMP;

FIG. 28, FIG. 29 and FIG. 30 are schematic diagrams showing how a perception module operates; and

FIG. 31 is a flow diagram showing a perpetual giving method according to the present invention.

### DETAILED DESCRIPTION OF THE INVENTION

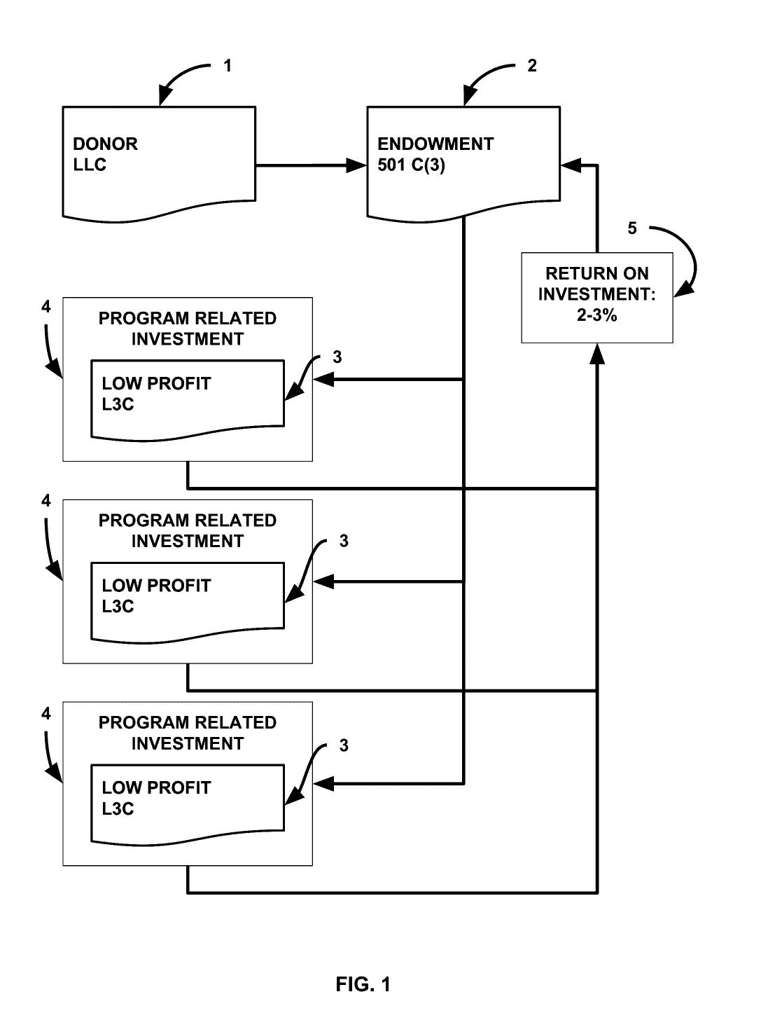

Referring to FIG. 1, a virtual representation (computer rendering) of a donor 1 in the MPG (Method for Perpetual Giving/Good) system is shown. The Donor 1 is structured as a corporate LLC due to its compatibility with sole member status. The MPG system keeps track of all of their donations, donation preferences, return on investments etc. (Note: LLC is a Limited Liability Corporation under US laws its equivalent in the UK is Limited Liability Partnership (LLP)). A virtual representation (computer rendering) of the endowment fund 2 is shown. The MPG system keeps track of the members of the Board, the balance and expenditure history of the investment capital etc. Referring to low profit L3C (Low Profit Limited Liability Corporation) 3, a virtual representation (computer rendering) of multiple L3C entities. The MPG system keeps track of their management, expenses, revenue, projected profit, actual profit. Referring to program related investment 4, each low profit L3C 3 has an associated program that defines the category of investment made. Referring to return on investment 5, due to the tax implications of an L3C structure, lowrisk investments are accompanied by low profit margins from investments.

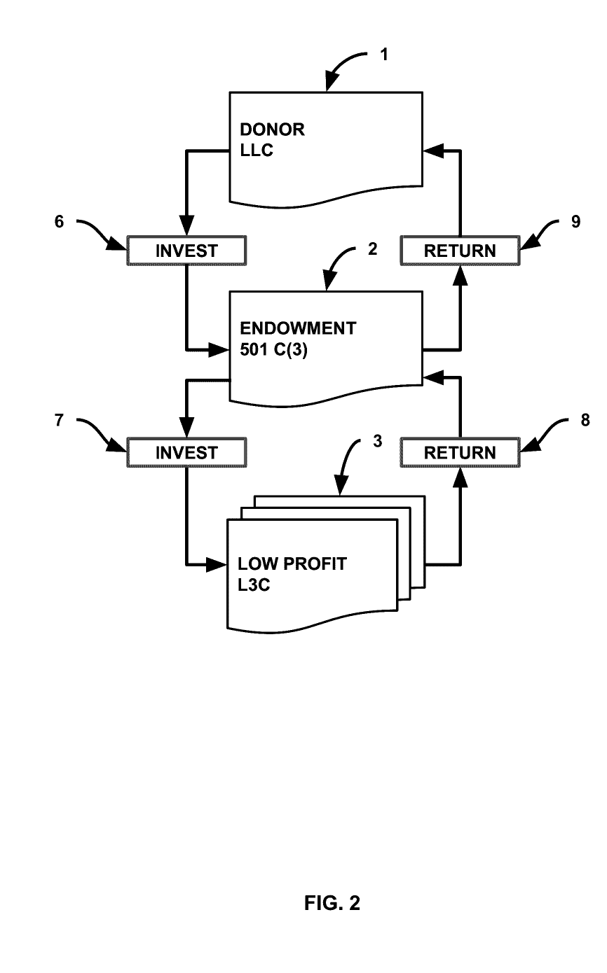

Referring to reference numeral 6 of FIG. 2, the donor 1, structured as an LLC, invests money into an endowment fund and has practically become partners with all other parallel investors into that fund. Referring to invest 7, by using sophisticated algorithm based investment recommendations, money from the endowment fund 2 is channeled and distributed amongst many small scale L3C that are structured for low risk and low gain profits. Referring to Return 8, the low profit margin returns on original investments are sent back to the endowment fund which the partners control. Referring to Return 9, depending on the performance of the fund on the long term, the Donor LLC receives profit margins that are proportionate to the original amount that was invested.

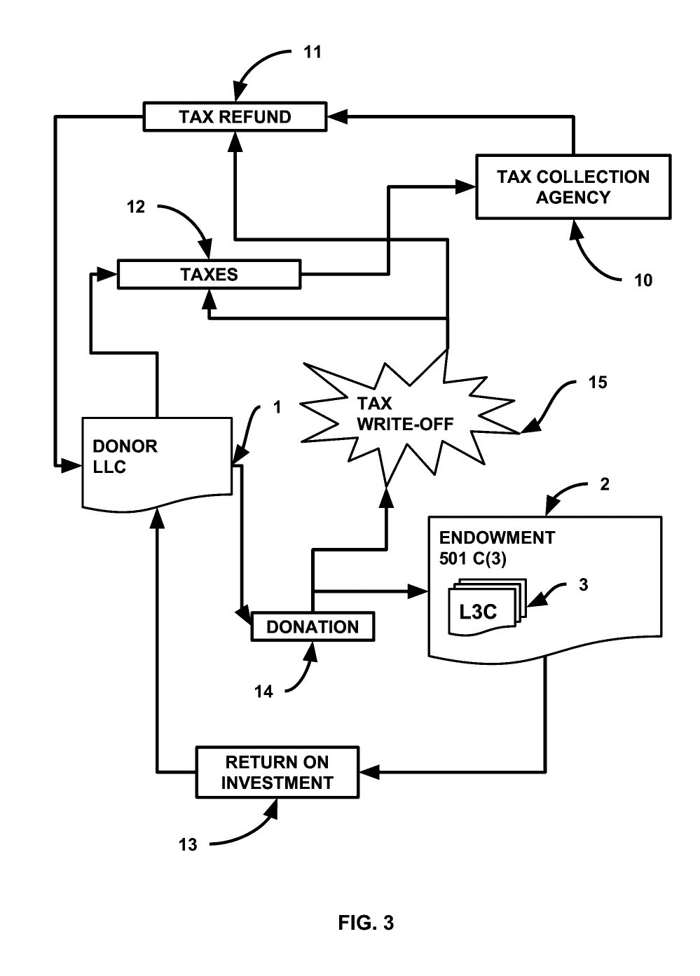

Referring to FIG. 3, the relevant authority 10 that imposes tax collection on businesses within its jurisdiction (e.g. Internal Revenue Service (IRS) in USA, Her Majesty's Revenue & Customs (HMRC) in UK) is shown. Referring to Tax Refund 11, because of earlier tax write offs 15, the donor LLC 1 receives a Tax Refund due to the excess that was paid the prior year (before the tax write off had effect). Referring to taxes 12, taxes are paid from the Donor LLC to the Tax Collection Agency 10. Referring to return on investment 13, profits are returned from the endowment fund 2 and hence by extensions the low profit L3Cs 3. Referring to Donation 14, the donor LLC transfers money as an investment to the endowment fund, yet is legally considered a donation. This usually leads to the tax write off 15. With the tax write off 15, the investments performed as donations become a means of reducing tax burden to further the investment cycle in the medium to long term.

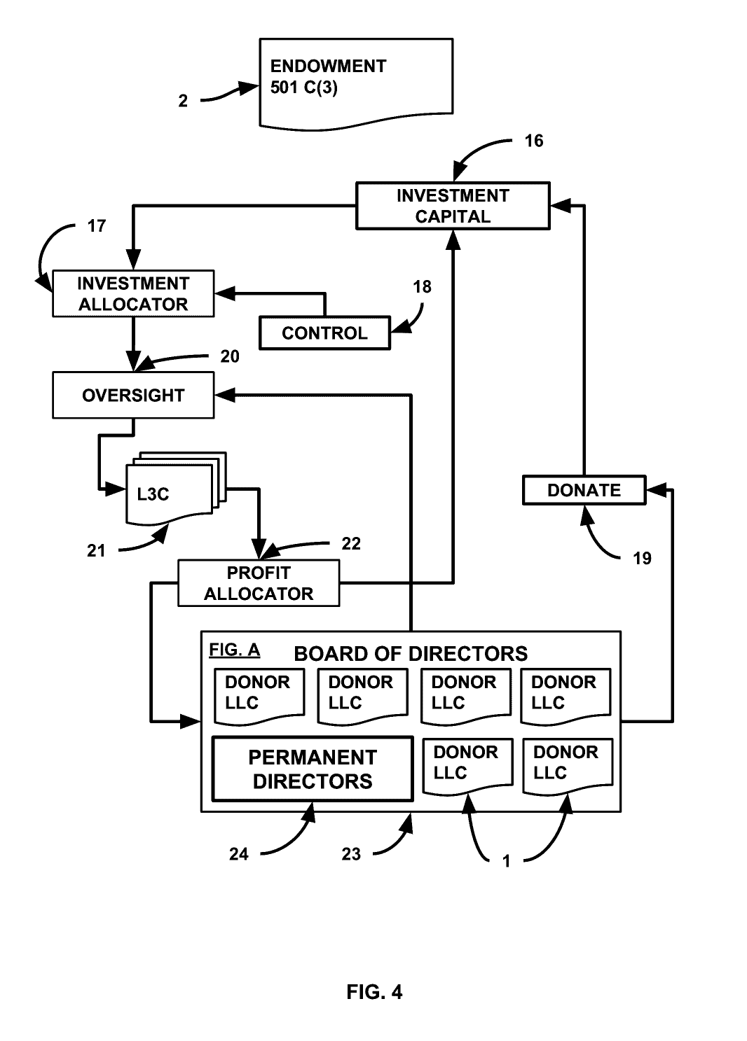

Referring to FIG. 4, the Donor LLCs compose the board of directors 23, which organize the main pool of funds at Investment Capital 16. Funds are transferred via donation. The investment allocator 17 is an artificially intelligent program that makes highly confident recommendations to the board of directors 23. Referring to control 18, the board of directors collectively exert their investment preferences to the investment allocator 17. This may include tweaking the criteria and large scale variables that define the preferences of the artificially intelligent software, or also the direct approval or denial of investment recommendations. Referring to Donate 19, upon approval of an investment allocator recommendation, the individual members of the board submit their preferred investment amount as a donation. The oversight module 20 is used for investment transparency as each member of the board is entitled to understand the financial decisions of his/her partners. Referring to L3C 21, the L3Cs are individually and separately managed. They receive investments and profit low yet consistent revenue streams (typically). Also see 3. The profit allocator 22, an extension of the artificial intelligence of the investment allocator 17, sends highly confident recommendations to the board for how much of the money should be retained within the L3Cs as reinvestments, and how much should be delegated back to the board of directors (for further investment). The board of directors 23 consists of members that act legally within LLC sole membership status. The permanent directors 24 are member donor LLC(s) that have a large share of stake in the investment capital 16.

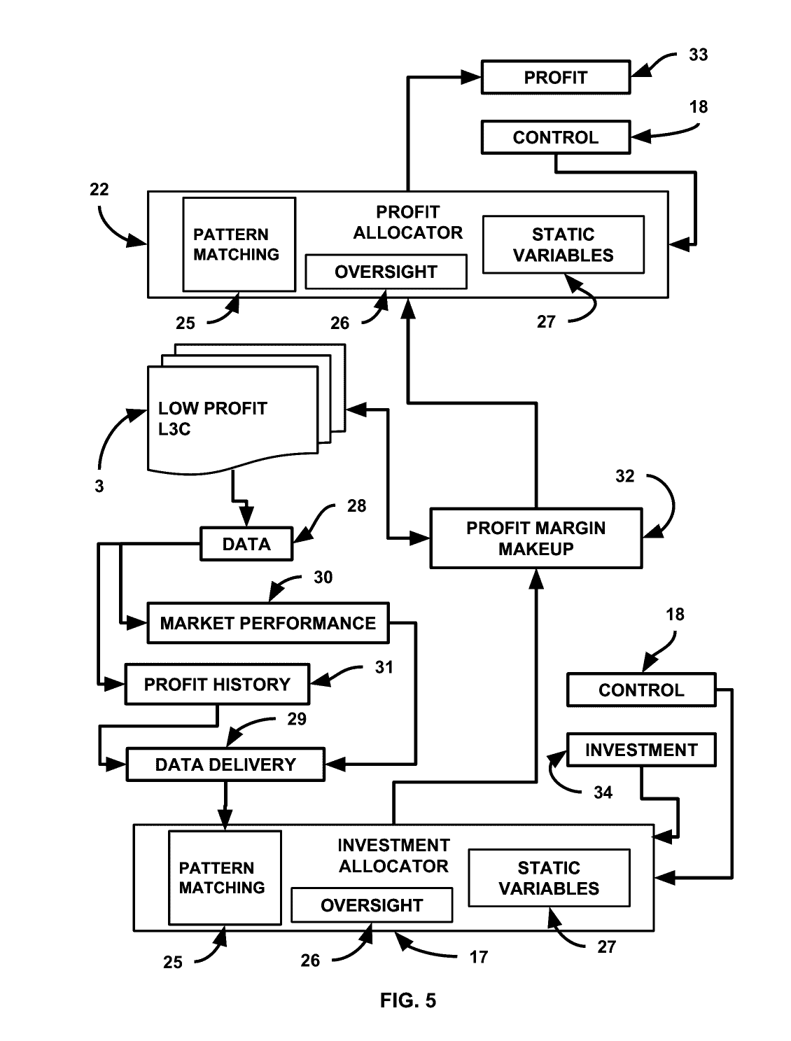

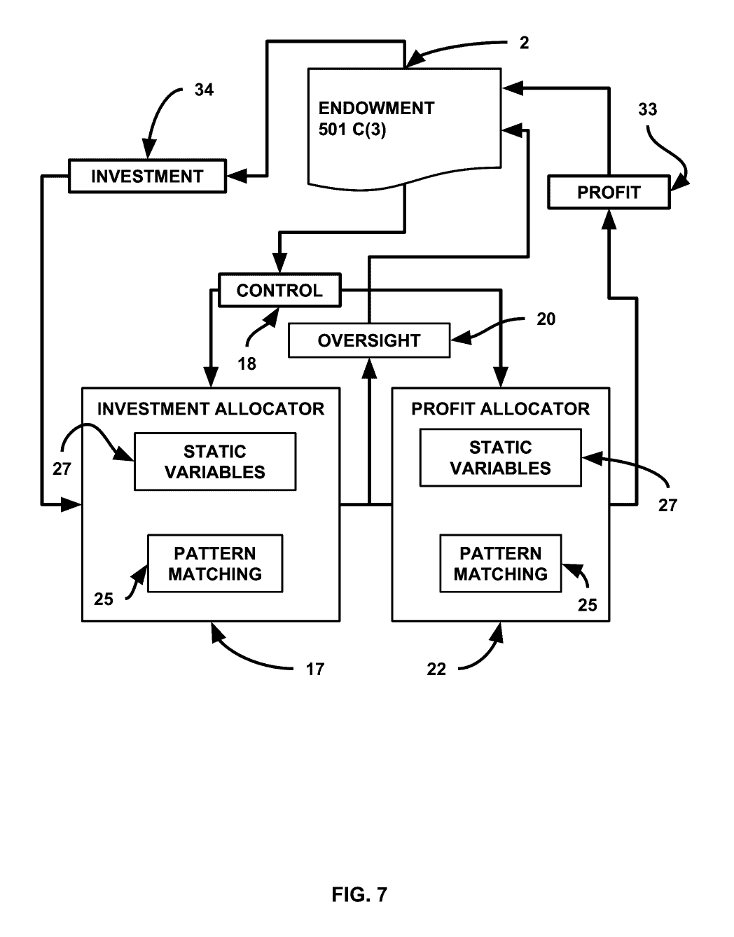

Referring to FIGS. 5 and 7, Pattern Matching 25 is performed as an intelligent function to designate profit and investment allotment. Referring to oversight 26, the board of directors exerts control over internally transparent financial transfers (also see 20). Static variables 27 represent aspects of the intelligent algorithm that are modifiable as per variables that have large scale and gradual influence over intelligence behavior. Historical performance data 28 can be used to assess market performance 30 and profit history 31. Referring to data delivery 29, the appropriate data (market performance and profit history) are delivered for the pattern matching 25 of the investment allocator 17. Market performance 30 indicates general trends of the related L3C 3 industry/market. Profit history 31 indicates specific performing trends concerning the acting L3C 3. Referring to profit margin makeup 32, a data series constitutes the specific profit composition of all the active L3Cs. This is like a general summary report that indicates which L3C 3 is making money, which is practically breaking even, and which is incurring a loss. Such information is passed onto the profit allocator 22 so that profit can be distributed correctly. This data series also aides in the decision making concerning the distribution of the next batch of investments. Profit 33 represents potential net profit of all of the L3C's combined efforts. Investment 34 represents initial investments made into the system, apportioned by the investment allocator 17.

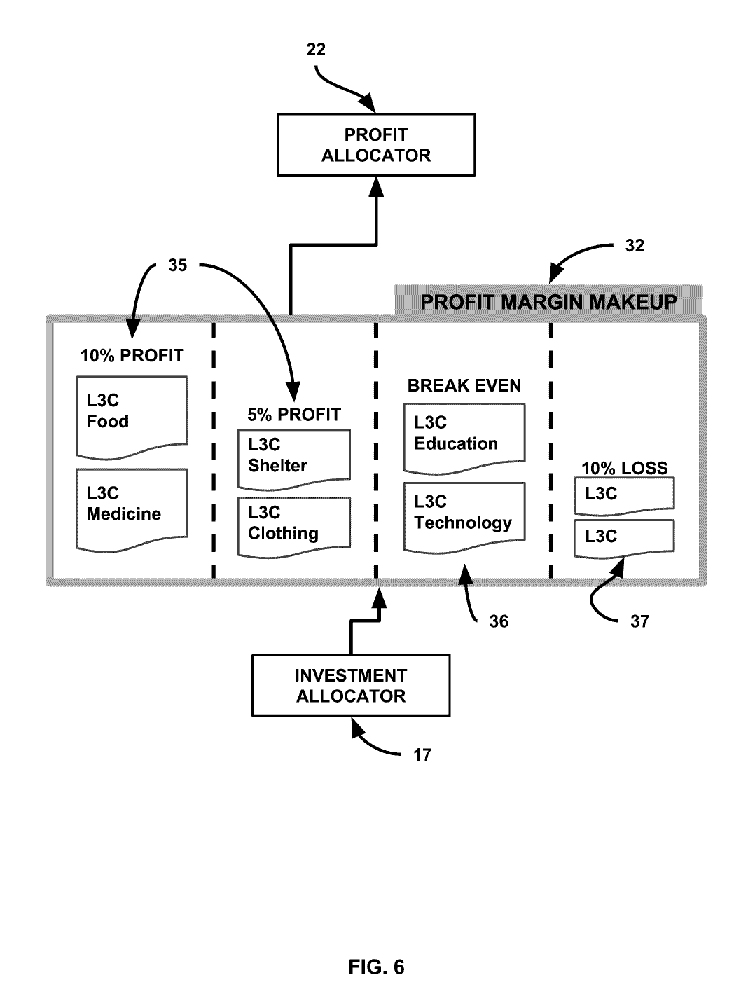

Referring to 5/10% profit 35 of FIG. 6, L3Cs that have been marked as have a net profit. Such L3Cs may span different sectors and industries such as Food, Medicine, Shelter etc. Referring to breakeven 36, L3Cs that have practically broken even on their profit margins. Referring to 10% loss 37, L3Cs that have incurred a loss in regards to the initial amount of money that was put in. This loss is typically mitigated by the tax write off 15 that was earned earlier.

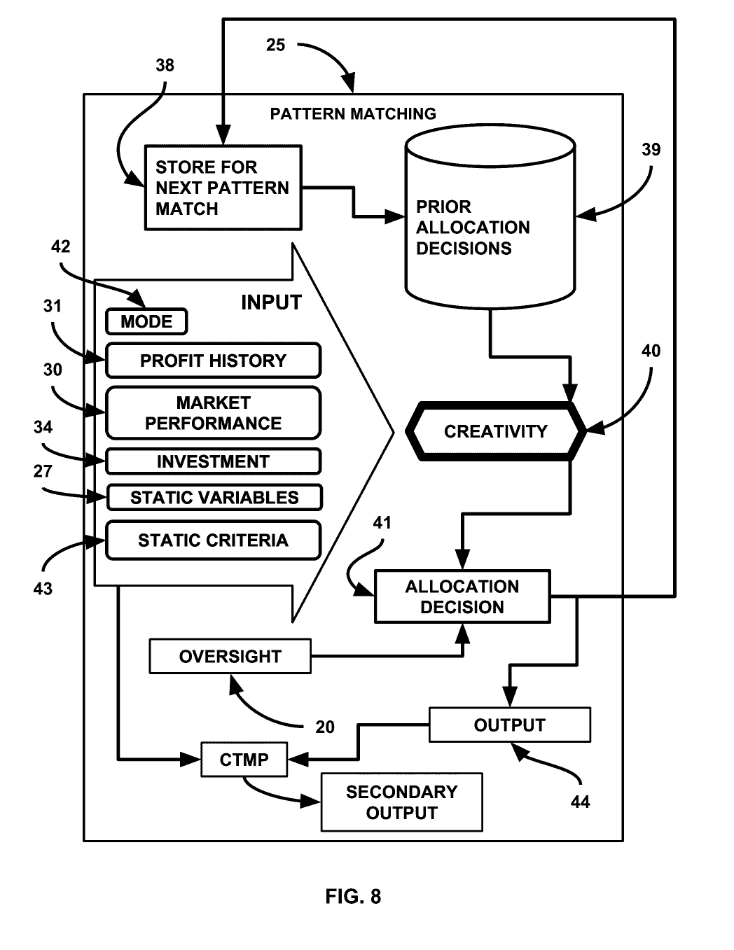

Referring to store for next pattern match 38 of FIG. 8, profit and/or investment allocation decisions are stored for future reference. Such reference is made especially by the pattern matching 2 automated system. All prior allocation decisions 39 have been stored so that they may become a frame of reference for future allocation decisions. The creativity module 40 uses the prior allocation decisions 39 as well as an assortment of complex variables (including profit history 31, market performance 30 etc.) to create new variations of allocation decisions which reflect the changes in market trends. Such new allocation decisions are potential candidates for the next batch of investment and/or profit allocation. The finally agreed upon allocation decision 41 has been reached after performing trial and error candidate selection from the creativity module 40. Mode 42 is a creativity module 40 specific variable that modifies its function mode. (i.e. combine variables x, y, z. Or produce a differential comparison between a, b, and c etc.). Static criteria 43 is a creativity module 40 specific variable that contains static yet nonpermanent criteria for how it should go about forming new hybrid forms (i.e. Allocation Decisions). The final output 44 concerning the pattern matching module 25 contains the allocation decision or computer codes denoting failure to achieve an allocation decision (which may be due to insufficient variables etc.).

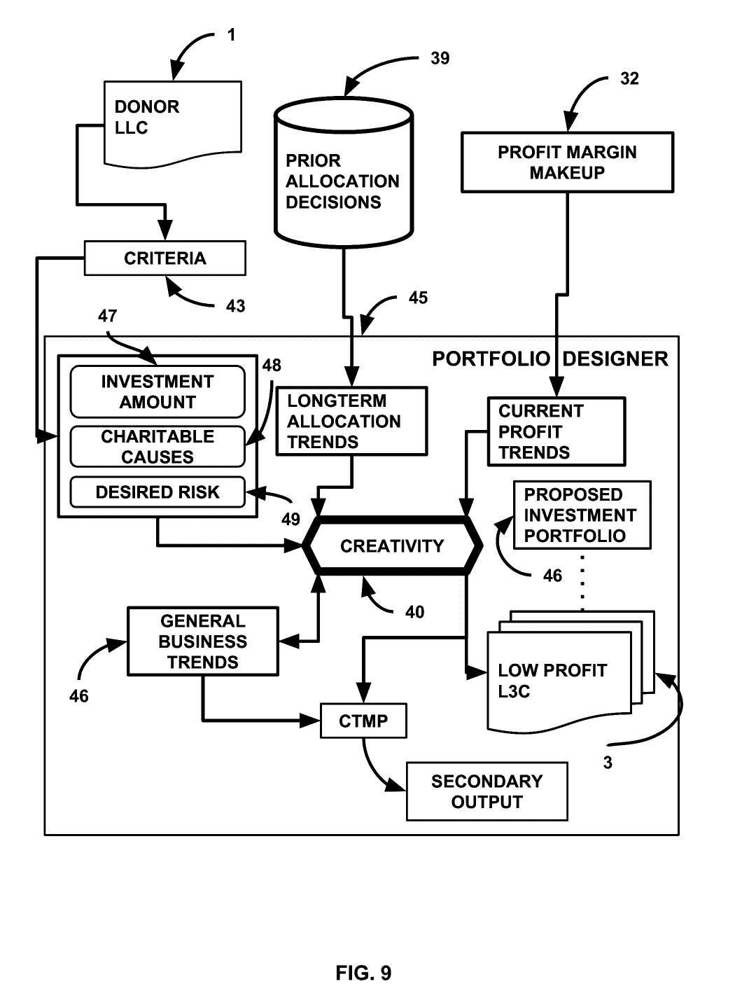

Referring to FIG. 9, the portfolio designer 45 will merge criteria from the Donor LLC 43 with current market data to automatically design an investment portfolio that acts as an educated recommendation. The final investment recommendation of general business trends 46 is given by the Portfolio Designer 45. Investment amount 47 is a makeup of the investor's investment preferences in regards to liquidity and size of investment. Charitable causes 48 is a makeup of the investor's investment preferences in regards to charitable causes. Desired risk 49 is a makeup of the investor's investment preferences in regards to risk of incurring a loss in contrast with high gain potential.

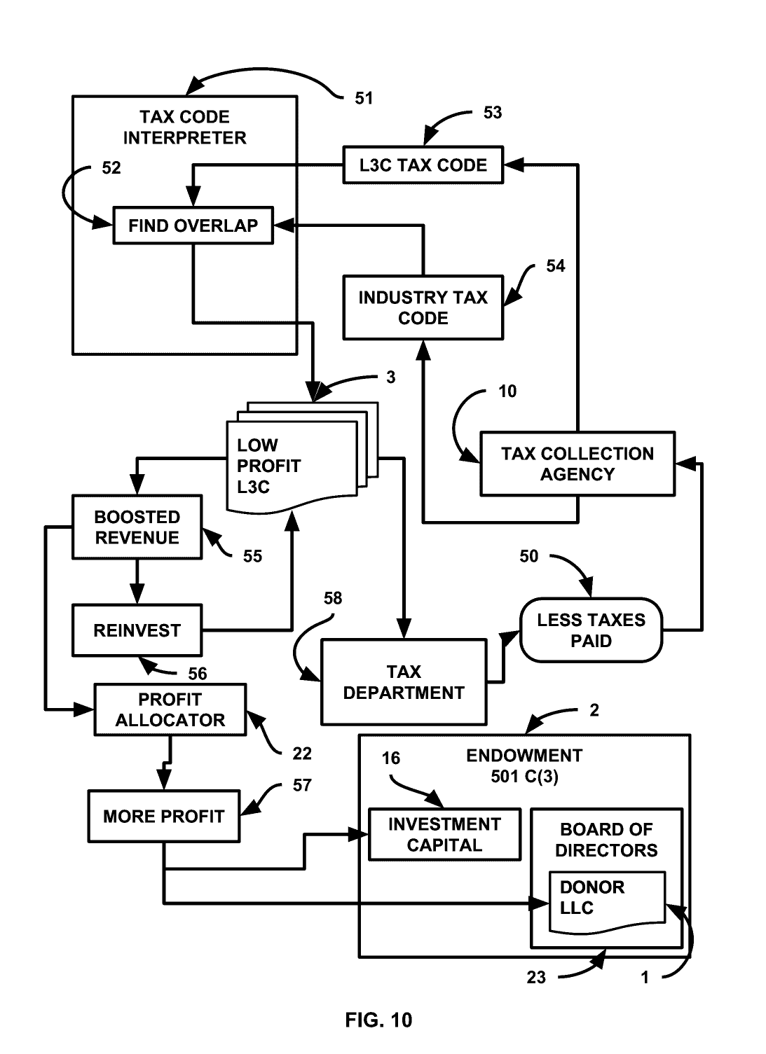

Referring to 50 of FIG. 10, less taxes are paid in retrospect considering the customized tax structure of the L3Cs in addition to the tax write offs 15 that are granted. Tax code interpreter 51 interprets tax codes so that meaningful dynamic operations can be performed with such derived data. Find overlap 52, a calculated overlap search is performed between the two inputs L3C tax code 53 and industry tax code 54. L3C tax code 53 represents the Tax Code concerning a specific L3C. Industry tax code 54 represents the Tax Code concerning the general industry at large. Referring to boosted revenue 55, less taxes paid 50 to the Tax Collection Agency 10 leads to a boosted overall revenue after tax deductions are considered. This is due to the customized L3C corporate structure that leverages points of efficiencies that are calculated in the Tax Code (see 52). Referring to reinvest 56, such boosted revenue 55 is partially allocated for reinvestment back into the L3C (allocation decision performed by the Investment Allocator 17). Referring to more profit 57, less taxes paid 50 to the Tax Collection Agency 10 leads to a usually higher profit margin which is to be partially reallocated back into the Endowment Fund 2. Tax department 58 is the tax department of the relevant organization that handles the calculation and submission of Taxes.

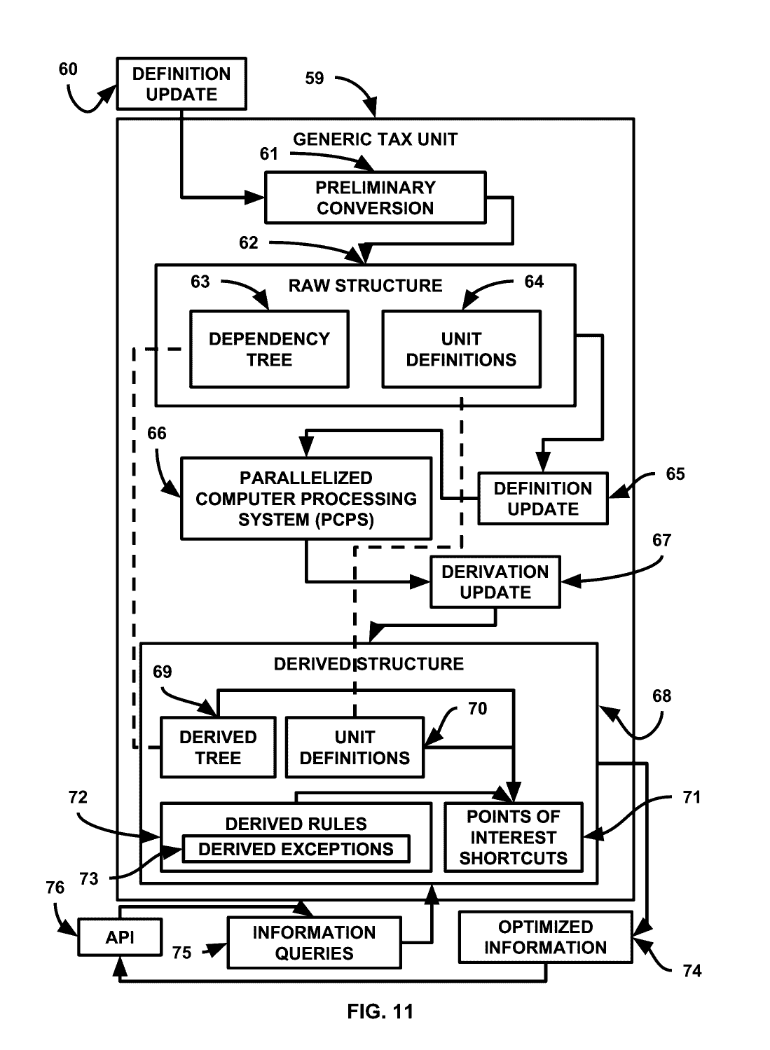

Referring to FIG. 11, the generic tax unit 59 is a file storage format that handles the information pertaining to any typical collection of tax laws (State tax laws. Federal tax laws etc.). This unit acts as the container for different kinds of information pertaining to the tax laws that are used differently depending on what kind of information processing is being done with the tax laws. Referring to definition update 60, the initial definition update refers to the generic tax unit container 59 receiving new and updated tax law information from the appropriate and verified source. For example, the definition update could be performed by a web crawler that automatically checks the .gov website for their tax laws concerning boat ownership. The preliminary conversion 61 takes the raw static list of laws and splits them into two major parts; the dependency tree 63 and the unit definitions 64. This is done so that static law lookups can be done as well, and is a form of minor optimization before the major optimization that occurs at the Parallelized Computer Processing System 66.

The raw structure 62 contains all of the tax information available yet in a static unoptimized method of being referenced. Dependency tree 63 contains a series of links of object dependencies. For example, OBJECT 1A REQUIRES→OBJECT 5C, OBJECT 5C CONDITIONAL→OBJECT 12B etc. The objects themselves are not defined here yet are defined in the unit definitions 64. Unit definitions 64 (in the raw structure 62) contains the names and descriptions/definitions of tax related objects (i.e. Law A3, Section 49B, Organization type L3C etc.) For example, if the API (application program interface) 76 simply needs to look up what the definition of a Class C boat is (in the context of taxes), then it can efficiently and effectively lookup the unit definitions 64 instead of parsing through the raw text from the .gov website. The unit definitions are also required to make sense of the dependency tree 63. The secondary definition update 65 (after the one at 60) passes on the same static information to the Parallelized Computer Processing System 66 to make the information dynamically accessible by the API 76.

The parallelized computer processing system (PCPS) 66 receives raw structure 62 as part of a definition update 65. The system then leverages highly scalable data mining processes that calculate the dynamic data sets the compose of the derived structure 68. Such scalable and parallel computer processing threads enable a large amount of tax analysis data mining to be performed simultaneously, which ultimately leads to an increase in the quality of allocation decisions. The derivation update 67 pushes the newly processed dynamic information to the derived structure every time there is a 60 & 67 derivation update. The derived structure 68 is an information container that contains dynamic points of information that reflect the original raw structure of the tax codes.

The derived tree 69 is a modified version of dependency tree 63. The difference is that the derived tree contains statements and assertions that have been implied from the originals. Such implications may include the combination of rules. For example, if a state law says that you are exempt from paying taxes if under age 18, and the same state's legal age to begin working is age 16, then the implication is that for 2 years between the ages of 16 and 18 someone can work without paying state taxes. Unit definitions 70 contain all the labels associated with the objects which are referenced by the derived tree 69 such as company type names etc. The algorithm deduces points of interest shortcuts 71 with a generic popularity algorithm. Such points are later referenced for being the building blocks of making comparisons between tax codes. By comparing what matters first, the efficiency of the calculations is improved. Derived rules 72 are conclusions that are inherited by the derived tree. This is where the example of 69 (age 16-18 don't pay taxes) will be stored. Referring to 73, derived exceptions to derived rules 72 are shown. Referring to optimized information 74, the resultant derived structural information has been optimized for data analysis purposes. This enables the functionality and efficiency of an API (application program interface) 76 which allows MPG as a whole to access tax interpretations. Information queries 75 are the requests from the API to provide such and such information concerning the tax code. The API 76 can be any intended program that seeks information from the Generic Tax Unit 59 and hence the derived structure.

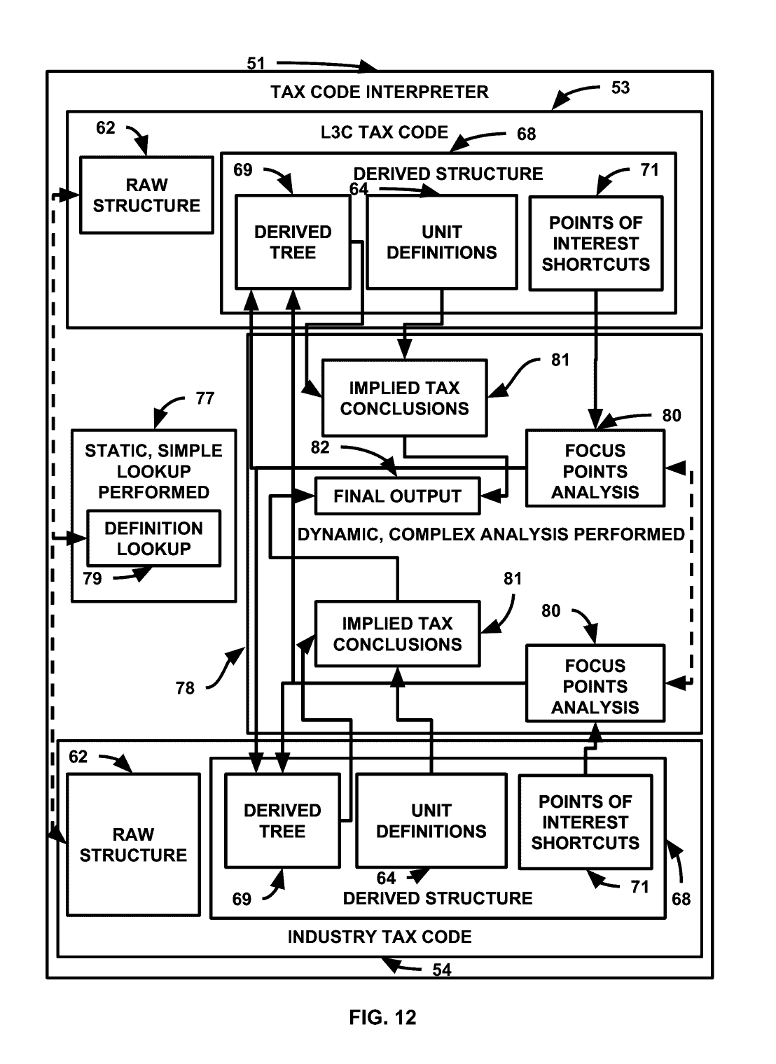

Referring to static, simple lookup performed 77 of FIG. 12, for simple information queries and case scenarios that may require the original raw tax structure to be referenced, the raw structures of both tax codes (L3C 53 and Industry 54) are compared. Referring to dynamic, complex analysis performed 78, for complex and/or atypical API 76 requests, the derived structures of both tax codes are referenced. Definition lookup 79 is the primary module of 77 static lookup, a simple definition lookup. Focus points analysis 80 will synchronize the points of interests between both tax codes. Such overlaps and patterns that are found are pushed for reference from the derived tree 69 of both tax codes for further expansion of information complexity, scope and quality. Referring to implied tax conclusions 81, after the information that has emerged from the derived trees 69 have been matched with their respective definitions from unit definitions 64, conclusions concerning the tax queries have been reached. Referring to final output 82, such tax conclusions from 81 are pushed in response to the API 76 request. These tax interpretation conclusions enable the creativity module to make better suited hybrid forms of financial allocation decisions and the CTMP to independently criticize financial allocation decisions according to the information reported by API 76.

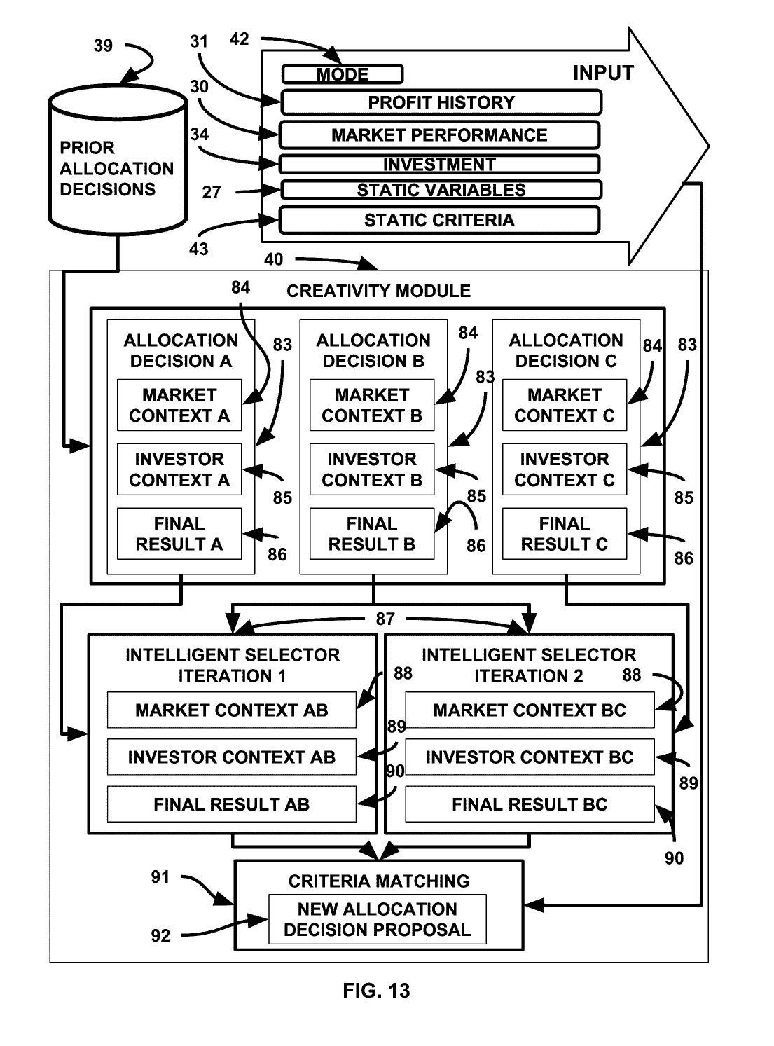

Referring to 83 of FIG. 13, different prior allocation decisions are referenced by the Creativity module to be used as a precedent for a newly formed allocation decision. Market contexts 84 include market performance 30 and profit history 31. Investor contexts 85 denotes the Donor LLC investment criteria 43. The final result 86 references what was the actual allocation apportionment that took place considering those market and investor contexts. Instances of the intelligent selector 87 are called which is a core component of the creativity module that performs intelligent comparisons and deductions whilst being provided two objects in the input for raw comparison 97 until the hybrid form has been pushed for output. Referring to market context 88, like market context 84 except merged from two allocation decisions according to the intelligent selector 87. Referring to investor context 89, like investor context 85 except merged from two allocation decisions according to the intelligent selector 87. Referring to final result 90, like final result 86 except merged from two allocation decisions according to the intelligent selector 87. Criteria matching 91 references the input criteria provided from pattern matching 25 to choose the hybrid forms the best suit market variables like market performance 30 and profit history 31. Referring to new allocation decision proposal 92, The final new hybridized allocation decision that is setup for final Creativity module output.

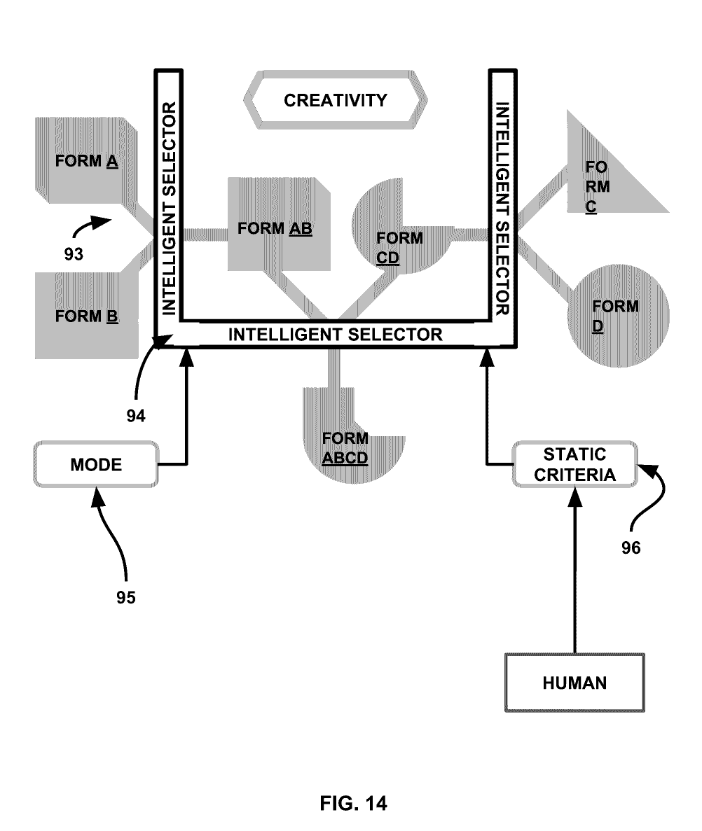

Referring to 93 of FIG. 14, two parent forms (prior forms) are pushed to the intelligent selector to produce a hybrid form. These forms can represent abstract constructs of data. Form A represents an average model of a financial allocation decision derived from the Prior Allocation Decisions DB (FIG. 13 DB 39). Form B represents new information released by a financial allocation on how it reacted to certain market and investor variables. The information in Form B allows the hybrid form produced (Form AB) to be a better financial allocation than what Form A represents. The intelligent selector 94 algorithm selects and merges new features into a hybrid form. Mode 95 defines the type of algorithm that the creativity module is being used in. This way the intelligent selector knows what parts are appropriate to merge, depending on the application that is being used. The system has preset modes to configure the merging process to deal with the types of incoming data sets and what the desired output type is. The amount of overlapping information is filtered through according to the ratio set by the static criteria 96. If the ratio is set to large then a large amount of form data that has remained consistent will be merged into the hybrid form. If the ratio is set to small then most of the hybrid form that will be constructed will have a very different form compared to its past iterations. When both data sets compete to define a feature at the same place in the form, a prioritization process occurs to choose which features are made prominent and which are overlapped and hidden. The manner in which overlapping points are merged. Most of the time there are multiple ways in which a specific merge can occur, hence the static criteria and mode direct this module to prefer a certain merge over another.

The Mode is set as ‘investment allocation’, so the intelligent selector knows that the expected input data is of an allocation decisions DB 39 representation (Form A) and of newly released information detailed a ruleset reaction to a market and/or investor variable (Form B). The attributed Mode defines the detailed method on how to best merge the new data with the old to produce an effective hybrid form. Static Criteria 96 is provided by a tax interpretation/investment analyst which provides generic customizations for how forms should be merged. Such data may include ranking prioritizations, desired ratios of data, and data to direct merging which is dependent on what Mode is selected. If the Mode is selected as ‘Investment Allocation’, then the resulting information from a failed allocation decision should heavily influence the allocation decisions DB 39 to strongly vary the composition of such an allocation. If the exploit keeps failing after such variations, then abandon the allocation completely.

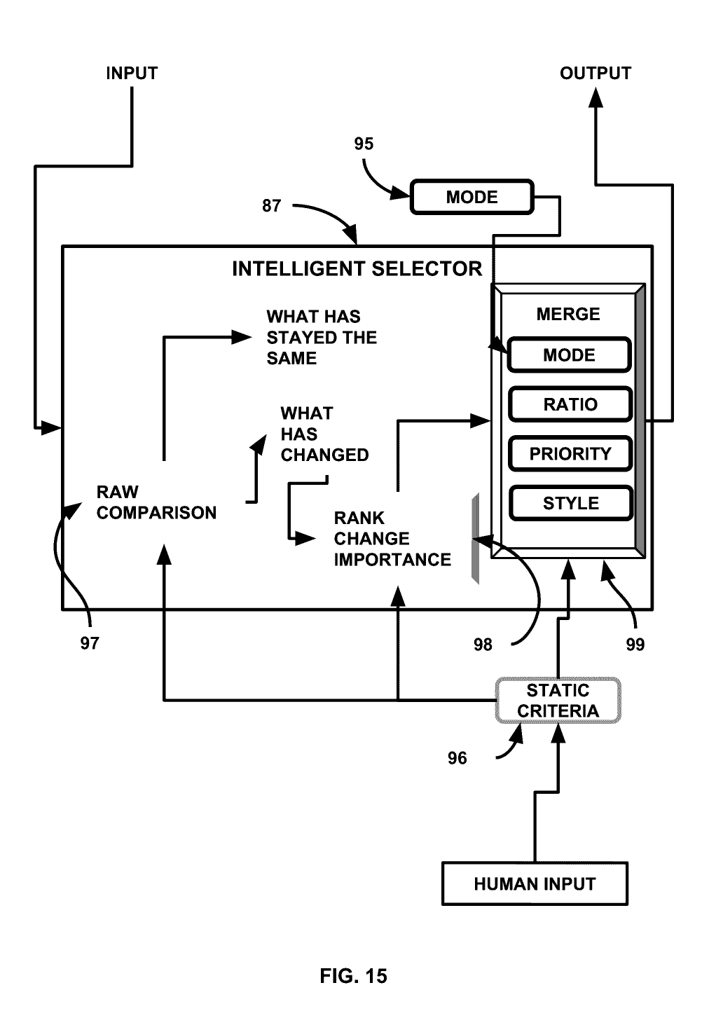

Referring to FIG. 15, a raw comparison 97 is performed on both incoming forms, dependent on the static criteria provided by the tax interpretation/investment. In an example, after a raw comparison was performed, the vast majority of the forms were compatible according to the static criteria. The only differences found was that Form A included a response that was flagged by the static criteria as ‘foreign’. This means the allocation decisions DB 39 representation Form B does not encompass/represent a certain irregularity that was found in Form A. Referring to rank change importance 98, ranks what changes are important and not important according to the provided static criteria. In an example, because an irregularity was found in Form A that is not represented in Form B, the Static Criteria recognizes that this irregularity is of crucial importance, hence it results in a prominent modification being made in the merging process to produce hybrid Form AB. Referring to 99 (merge—mode, ratio, priority, style), what remains the same and what is found to be different are reassembled into a hybrid form based off of the Static Criteria and the Mode that is being used. Such variations may include the ratio distribution of data, how important are certain data, and how the data should mesh/relate to each other. In an example, the rank importance of the irregularity composition is received. After the appropriate adjustments are made, a process which is guided by the static criteria discerns if that reaction to the irregularity is incompatible with other parts of the data. The merging process then modifies such preexisting data so that the irregularity fix can blend in effectively with the preexisting data.

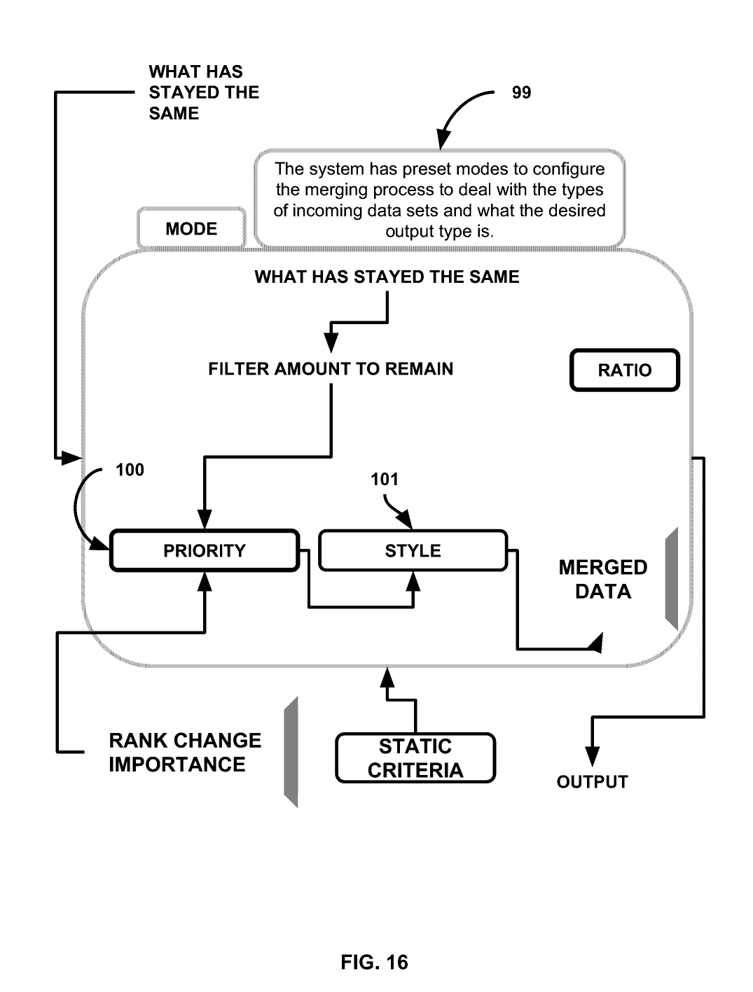

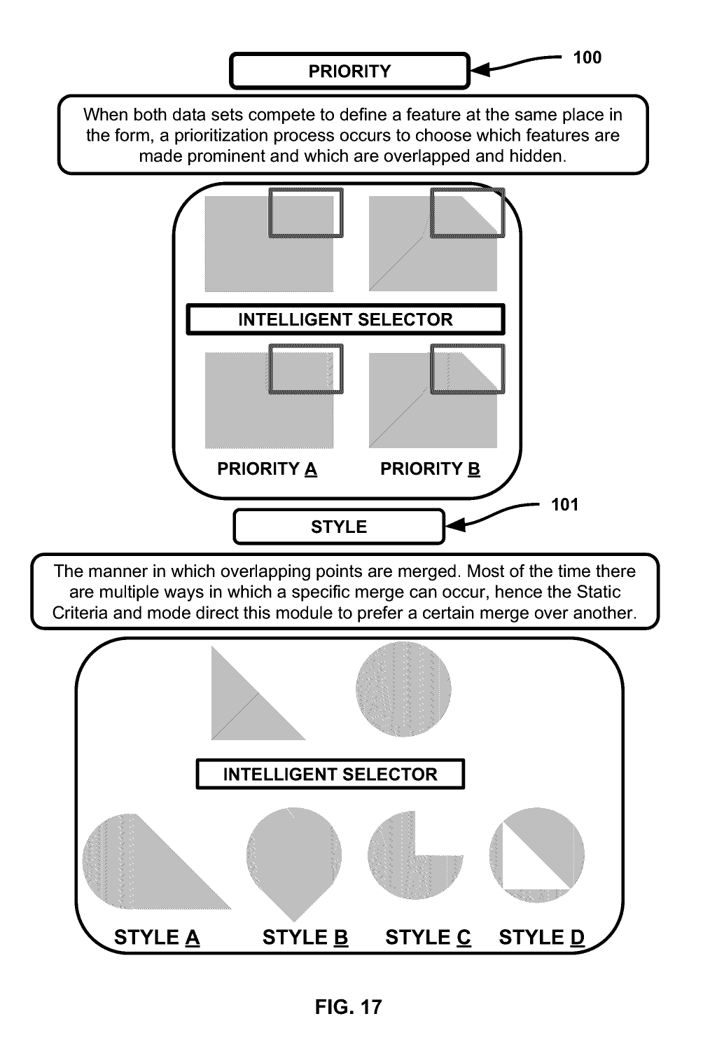

Referring to priority 100 of FIG. 16, when only one trait can occupy a certain spot (highlighted in red), then a prioritization process occurs to choose which feature. When both data sets compete to define a feature at the same place in the form, a prioritization process occurs to choose which features are made prominent and which are overlapped and hidden. Referring to FIG. 17, the two potential outcomes are shown. In actuality, only one of these forms may be the final output. Referring to style 101, the manner in which overlapping points are merged. Most of the time there are overlapped forms between features, hence a form with merged traits can be produced. The manner in which overlapping points are merged. Most of the time there are multiple ways in which a specific merge can occur, hence the Static Criteria and mode direct this module to prefer a certain merge over another. In the embodiment: When a triangle and a circle are provided as input forms, a ‘pacman’ shape can be produced.

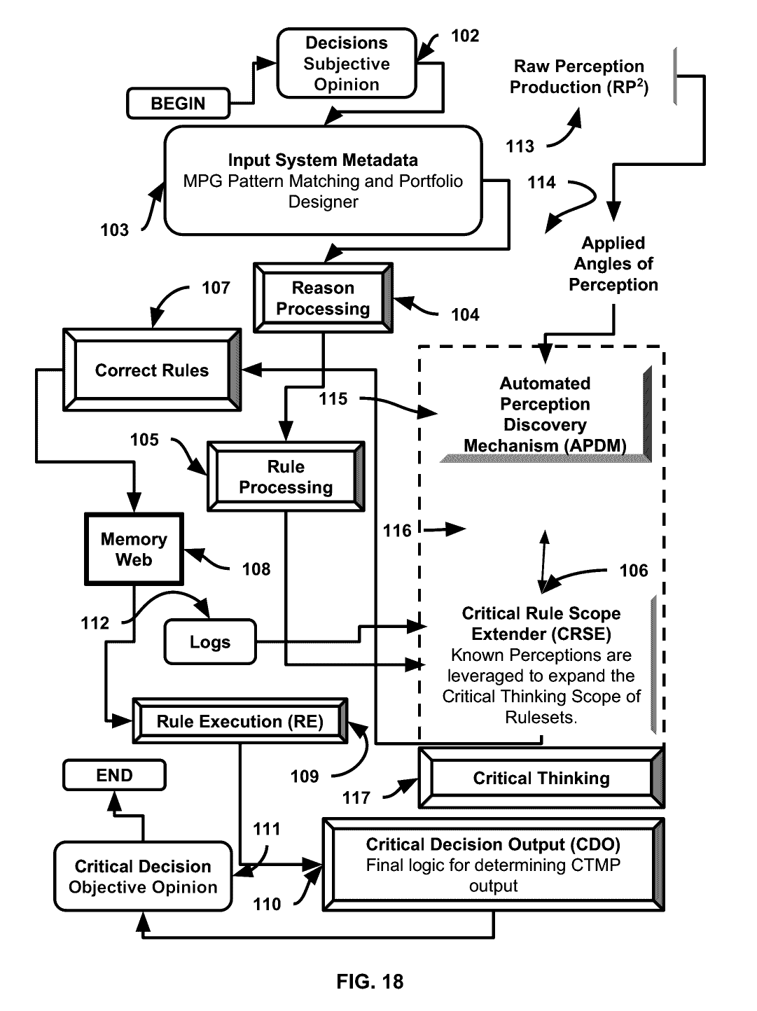

Referring to FIG. 18, subjective opinion decisions 102 indicates the original subjective decision provided by the input algorithm, which in this case is MPG pattern matching and allocation decision making. Input system metadata 103 indicates raw metadata provided by MPG which describes the mechanical process of MPG and how it reached such decisions. Reason processing 104 will logically understand the assertions being made by comparing attributes of properties. In rule processing 105, a subset of reason processing 104, the resultant rules that have been derived are used as a reference point to determine the scope of the problem at hand. Critical rule scope extender 106 will take the known scope of perceptions and upgrade them to include critical thinking scopes of perceptions. Correct rules 107 indicates correct rules that have been derived by using the critical thinking scope of perception. In memory web 108, the market variables (market performance 30 and profit history 31) logs are scanned for fulfillable rules. Any applicable and fulfillable rules are executed to produce investment allocation override decisions. In rule execution 109, rules that have been confirmed as present and fulfilled as per the memory's scan of the chaotic field are executed to produce desired and relevant critical thinking decisions. In critical decision output 110, final logic for determining the overall output of CTMP by comparing the conclusions reached by both perception observer emulator (POE) 119 and rule execution (RE) 109. Critical decision 111 is the final output which is an opinion on the matter which attempts to be as objective as possible.

Logs 112 are the raw information that is used to independently make a critical decision without any influence or bias from the subjective opinion of the input algorithm (MPG). Raw perception production 113 indicates rules that have been confirmed as present and fulfilled as per the memory's scan of the chaotic field are executed to produce desired and relevant critical thinking decisions. Applied angles of perception 114 indicates angles of perception that have already been applied and utilized by the input algorithm (MPG). Automated perception discovery mechanism (APDM) 115 indicates a module that leverages the creativity module that produces hybridized perceptions (that are formed according to the input provided by applied angles of perception 114) so that the scope of perception can be increased. 116 indicates the entire scope of perceptions available to the computer system. Critical thinking 117 indicates outer shell jurisdiction of rule based thinking which results in rule execution (RE) manifesting the rules that are well established concerning the CTMP input prompt but also new correct rules 107 that have been derived from within CTMP.

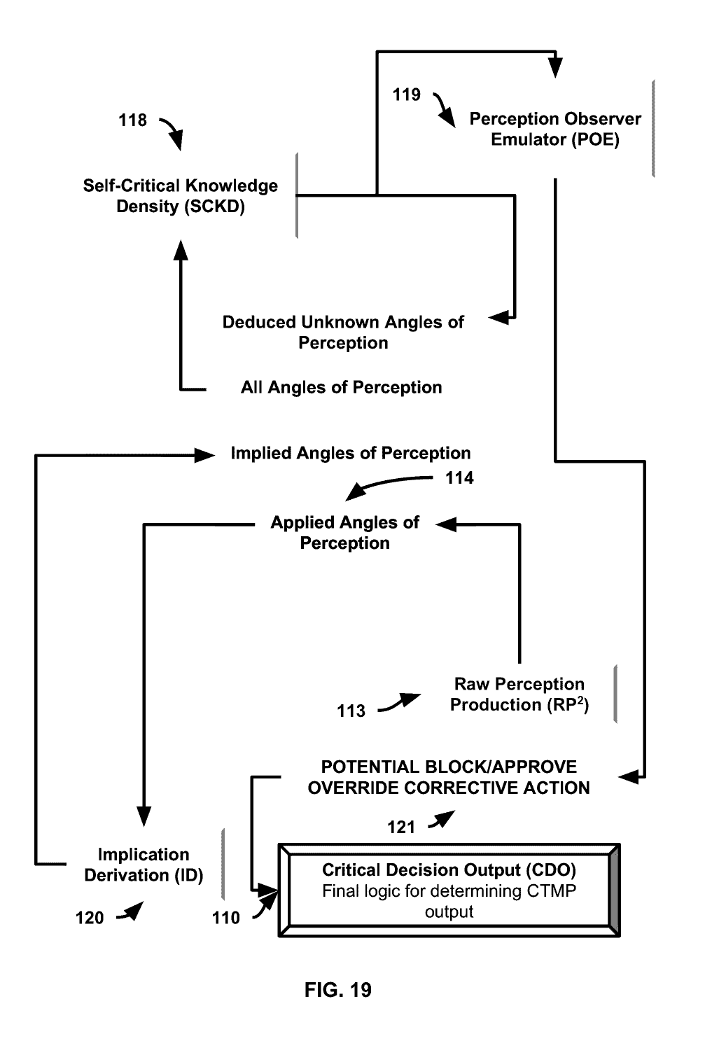

Referring to self critical knowledge density module 118 of FIG. 19, Incoming raw logs represent technical knowledge known by the input system (MPG). This Module estimates the scope and type of potential unknown knowledge that is beyond the reach of the reportable logs. This way the subsequent critical thinking features of the CTMP can leverage the potential scope of all involved knowledge, known and unknown directly by the system. Perception observer emulation 119 produces an emulation of the observer, and tests/compares all potential points of perception with such variations of observer emulations. Whilst the input are all the potential points of perception plus the enhanced data logs; the output is the resultant investment allocation decision produced of such enhanced logs according to the best, most relevant, and most cautious observer with such mixture of selected perceptions. Referring to implication derivation (ID) 120, derives angles of perception of data that can be implicated from the current known angles of perceptions. Referring to override corrective action 121, the final corrective action/assertion criticism produced by perception observer emulator (POE).

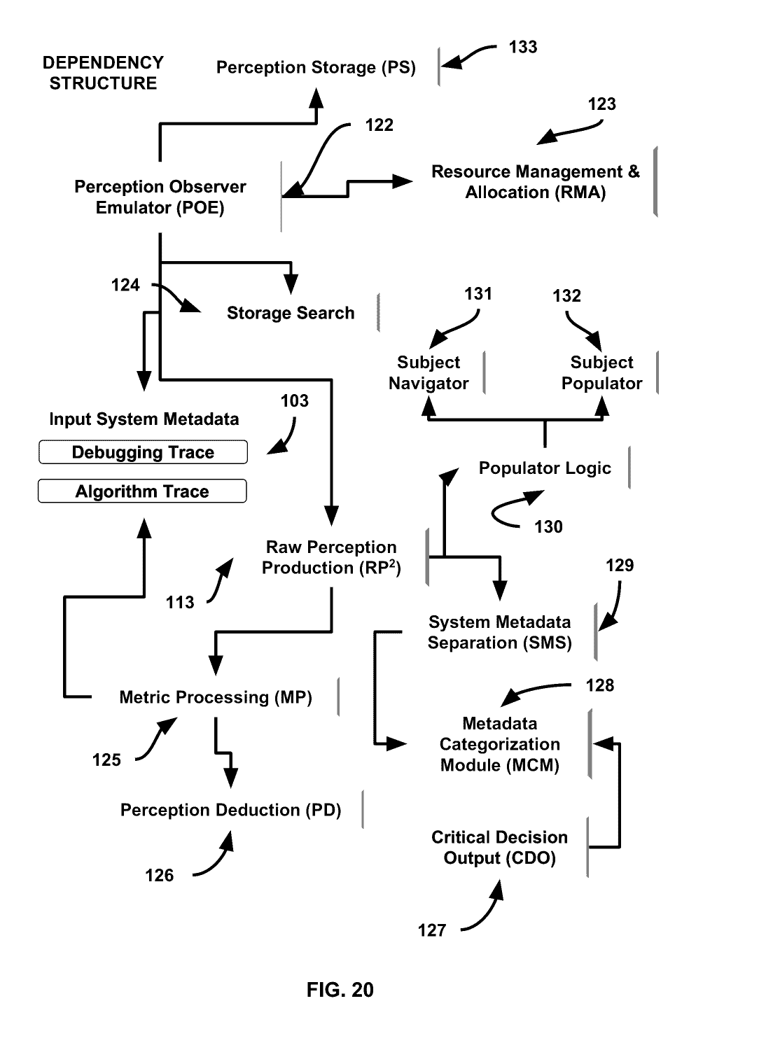

Referring to FIG. 20, a perception observer emulator 122 produces an emulation of the observer, and tests/compares all potential points of perception with such variations of observer emulations. Whilst the input are all the potential points of perception plus the enhanced data logs; the output is the resultant investment allocation decision produced of such enhanced logs according to the best, most relevant, and most cautious observer with such mixture of selected perceptions. Referring to resource management & allocation (RMA) 123, adjustable policy dictates the amount of perceptions that are leveraged to perform an observer emulation. The priority of perceptions chosen are selected according to weight in descending order. The policy can then dictate the manner of selecting a cut off, whether than be a percentage, fixed number, or a more complex algorithm of selection. Referring to storage search 124, The CVF derived from the data enhanced logs is used as criteria in a database lookup of the perception storage (PS). Metric processing (MP) 125 reverse engineers the variables from the Selected Pattern Matching Algorithm (SPMA) investment allocation to ‘salvage’ perceptions from such algorithm's intelligence. Perception deduction (PD) 126 uses a part of the investment allocation response and its corresponding system metadata to replicate the original perception of the investment allocation response. Critical Decision Output (CDO) 127 indicates final logic for determining CTMP output. Referring to Metadata Categorization Module (MCM) 128, debugging and algorithm trace are separated into distinct categories using traditional syntax based information categorization. Such categories can then be used to organize and produce distinct investment allocation responses with a correlation to market/tax risks and opportunities. Referring to System Metadata Separation (SMS) 129, input system metadata 103 is separated into meaningful investment allocation cause-effect relationships. Referring to Populator Logic 130, comprehensively assorts all the investment allocations with relevant market/tax risks, opportunities, and their respective responses. Subject Navigator 131 scrolls through all applicable subjects. Subject Populator 132 retrieves the appropriate investment risk and allocation correlated with the subject. Referring to 133, perceptions are indexed and stored. Perceptions, in addition to their relevant weight, are stored with the comparable variable format (CVF) as their index. This means the database is optimized to receive a CVF as the input query lookup, and the result will be an assortment of perceptions.

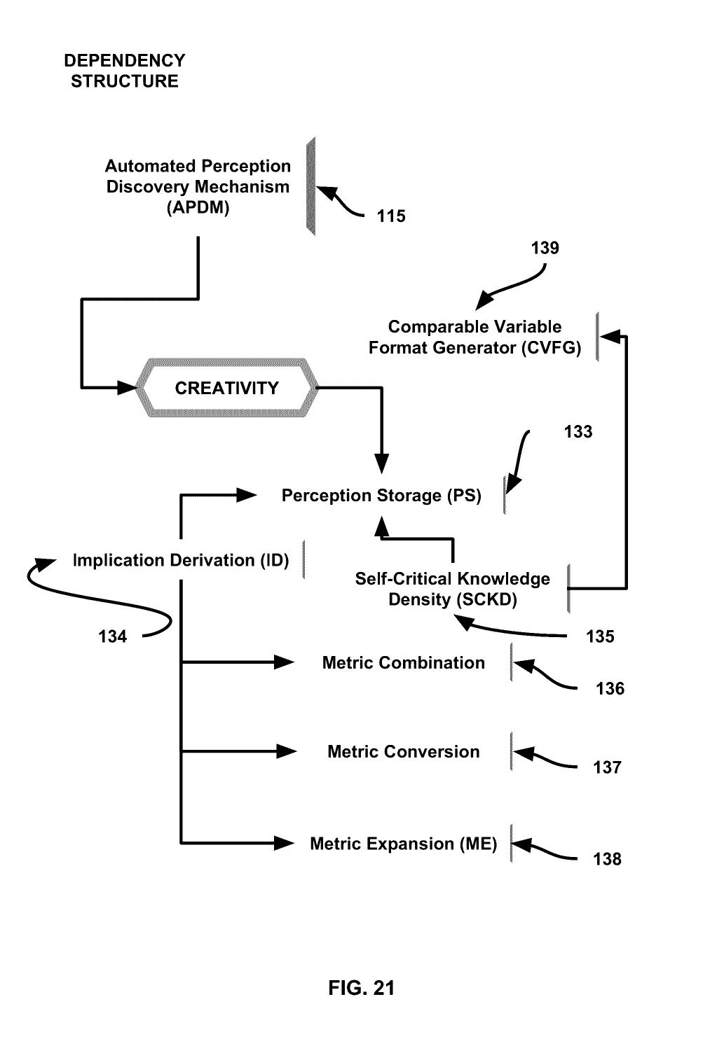

Referring to FIG. 21, Implication Derivation (ID) 134 derives angles of perception of data that can be implicated from the current known angles of perceptions. Referring to Self Critical Knowledge Density (SCKD) 135, incoming raw logs represent known knowledge. This module estimates the scope and type of potential unknown knowledge that is beyond the reach of the reportable logs. This way the subsequent critical thinking features of the CTMP can leverage the potential scope of all involved knowledge, known and unknown directly by the system. In metric combination 136, angles of perception are separated into categories of metrics. In metric conversion 137, individual metrics are reversed back into whole angles of perception. In metric expansion (ME) 138, the metrics of multiple and varying angles of perception are stored categorically in individual databases. The upper bound is represented by the peak knowledge of each individual Metric DB. Upon enhancement and complexity enrichment, the metrics are returned to be converted back into angles of perception and to be leveraged for critical thinking. In comparable variable format generator (CVFG) 139, stream of information is converted into comparable variable format (CVF).

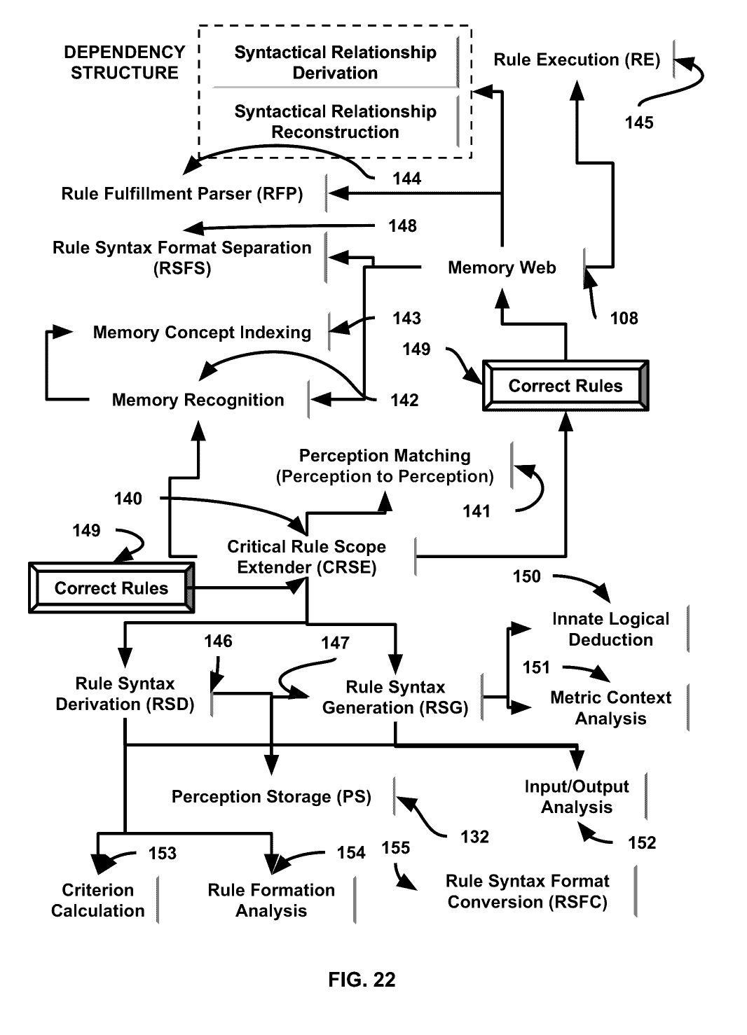

FIG. 22 shows the dependency structure of CTMP. In critical rule scope extender (CRSE) 140, known perceptions are leveraged to expand the Critical Thinking Scope of Rulesets. In Perception Matching 141, a Comparable Variable Format (CVF) is formed from the perception received from Rule Syntax Derivation. The newly formed CVF is used to lookup relevant Perceptions in the Perception Storage (PS) with similar indexes. The potential matches are returned to Rule Syntax Generation. In memory recognition 142, a chaotic field is formed from input data. Field scanning is performed to recognize known concepts. In memory concept indexing 143, the whole concepts are individually optimized into separate parts known as indexes. These indexes are used by the letter scanners to interact with the chaotic field. The rule fulfillment parser (RFP) 144 receives the individual parts of the rule with a tag of recognition. Each part is marked as either having been found, or not found in the chaotic field by memory recognition (MR) 142. The RFP can then logically deduce which whole rules, the combination of all of their parts, have been sufficiently recognized in the chaotic field to merit rule execution (RE). In rule syntax format separation (RSFS) 148, correct rules are separated and organized by type. Hence all the actions, properties, conditions, and objects are stacked separately. This enables the system to discern what parts have been found in the chaotic field, and what parts have not. In rule syntax derivation 146, logical ‘black and white’ rules are converted to metric based perceptions. The complex arrangement of multiple rules are converted into a single uniform perception that is expressed via multiple metrics of varying gradients. Rule syntax generation (RSG) 147 receives previously confirmed perceptions which are stored in Perception format. Engages with the perception's internal metric makeup. Such gradient based measures of metrics are converted to binary and logical rulesets that emulates the input/output information flow of the original perception. Rule syntax generation (RSG) 147 receives previously confirmed perceptions which are stored in Perception format. Engages with the perception's internal metric makeup. Such gradient based measures of metrics are converted to binary and logical rulesets that emulates the input/output information flow of the original perception. Rule Syntax Format Separation (RSFS) 149 Correct rules represent the accurate manifestation of rulesets that conform to the reality of the object being observed. Correct rules are separated and organized by type. Hence all the actions, properties, conditions, and objects are stacked separately. This enables the system to discern what parts have been found in the chaotic field, and what parts have not. Innate Logical Deduction 150, Uses logical principles, and hence avoidance of fallacies, to deduce what kind of rule will accurately represent the many gradients of metrics within the perception. To illustrate an example, it is like taking an analog sine wave (of a radio frequency etc.) and converting it into digital steps. The overall trend, position, and result is the same. However, the analog signal has been converted to digital. Metric Context Analysis 151, Analyzes the interconnected relationships within the perceptions of metrics. Certain metrics can depend on others with varying degrees of magnitude. This contextualization is used to supplement the mirrored interconnected relationship that rules have within the ‘digital’ ruleset format. Input/Output Analysis 152, Performs a differential analysis of the input and output of each perception (grey) or rule (black and white). The goal of this module is to ensure that the input and output remains as similar or identical as possible after transformation (from grey to black/white and vice versa). Criterion Calculation 153, Calculates the criteria and task of the input rules. This can be translated to the ‘motivation’ behind the ruleset. Rules are implemented for reasons, which can be understood by implication or by an explicit definition. Hence by calculating the reason for a why a ‘digital’ rule has been implemented, that same reason can be used to justify the makeup of metrics within a perception that seeks the same input/output capabilities. Rule Formation Analysis 154, Analyzes the overall composition/makeup of rules and how they interact with each other. Used to supplement the mirrored interconnected relationship that metrics have within an ‘analog’ perception. Rule Syntax Format Conversion (RSFC) 155, Rules are assorted and separated to conform to the syntax of the Rule Syntax Format (RSF).

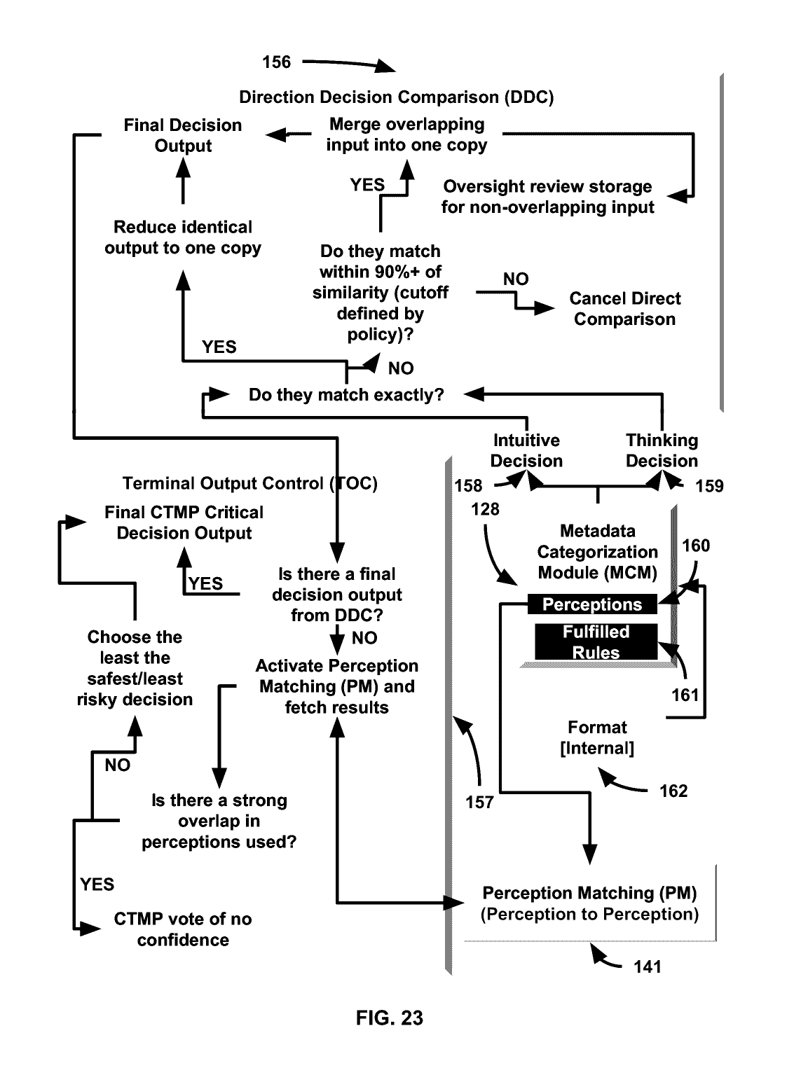

FIG. 23 shows the final logic for processing intelligent information in CTMP. The final logic receives intelligent information from both Intuitive/Perceptive and Thinking/Logical modes (Perception Observer Emulator (POE) and Rule Execution (RE) respectively). In Direct Decision Comparison (DDC) 156, both decisions from Intuition and Thinking are compared to check for corroboration. Key difference is that no Meta-metadata is being compared yet, because if they agree identically anyways then it is redundant to understand why. Terminal Output Control (TOC) 157, last logic for determining CTMP output between both modes Intuitive 158 and Thinking 159. Intuitive Decision 158 is one of two major sections of CTMP which engages in critical thinking via leveraging perceptions. See Perception Observer Emulator (POE) 119.

Thinking Decision 159 is the other one of two major sections of CTMP which engages in critical thinking via leveraging rules. See Rule Execution (RE) 109. Perceptions 160 is data received from Intuitive Decision 158 according to a format syntax defined in Internal Format 162. Fulfilled Rules 161 is data received from Thinking Decision 160 which is a collection of applicable (fulfillable) rulesets from Rule Execution (RE) 109. Such data is passed on in accordance with the format syntax defined in Internal Format 162. Internal Format 162, the Metadata Categorization Module (MCM) 128 is able to recognize the syntax of both inputs as they have been standardized with a known and consistent format that is used internally within CTMP.

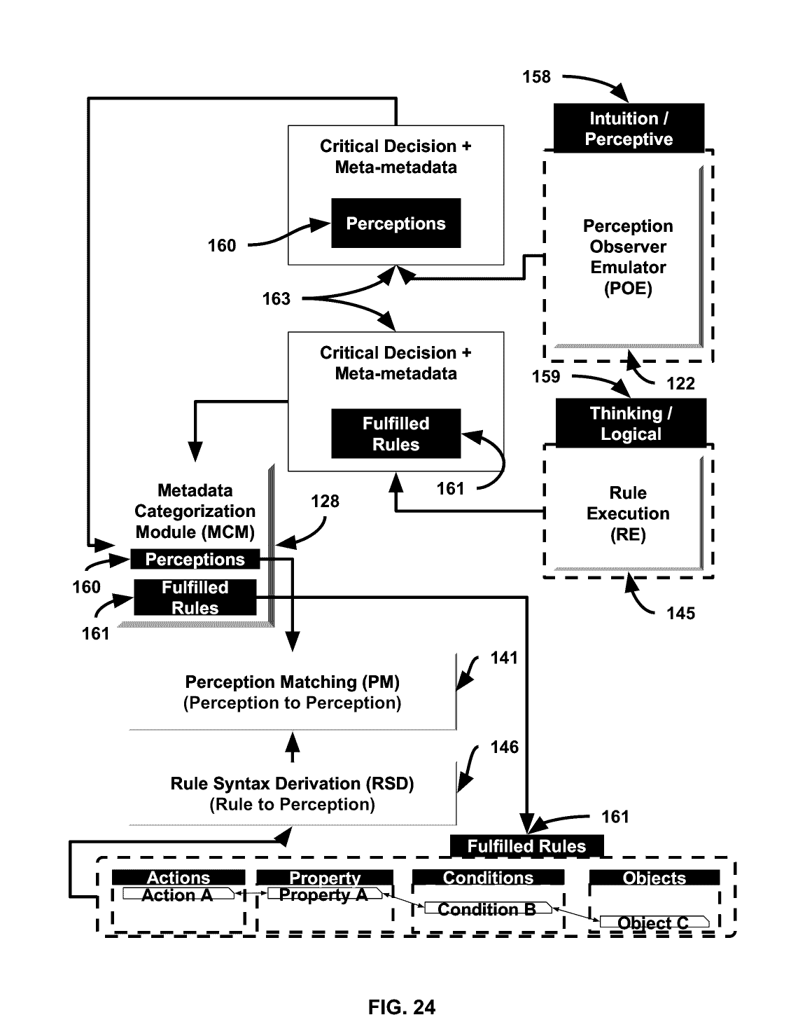

FIG. 24 shows the two main inputs of Intuitive/Perceptive and Thinking/Logical assimilating into a single terminal output which is representative of CTMP as a whole. Critical Decision+Meta-metadata 163 is a digital carrier transporting either Perceptions 160 or Fulfilled Rules 161 according to the syntax defined in Internal Format 162.

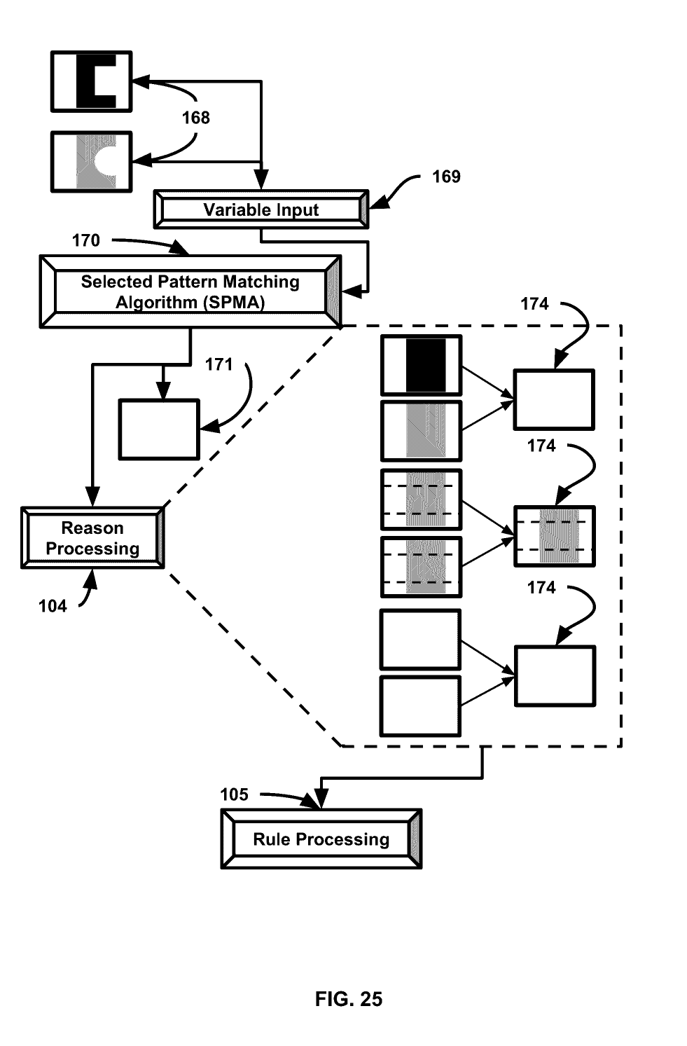

FIG. 25 shows the scope of intelligent thinking which occurs in the original Select Pattern Matching Algorithm (SPMA). Input Variables 168 are the initial financial/tax allocation variables that are being considered for Reason and Rule processing. CTMP intends on criticizing them and becoming an artificially intelligent second opinion. Variable Input 169 receives input variables that define a financial/tax allocation decision. Such variables offer criteria for the CTMP to discern what is a reasonable corrective action. If there is an addition, subtraction, or change in variable; then the appropriate change must be reflected in the resultant corrective action. The crucial objective of CTMP is to discern the correct, critical change of corrective action that correctly and accurately reflects a change in input variables. Selected Pattern Matching Algorithm (SPMA) 170, the selected pattern matching algorithm attempts to discern the most appropriate action according to its own criteria. For this usage the criteria are based on investment allocation algorithms from CTMP. Resultant Output Form 171 is the result produced by the SPMA 170 with initial input variables 168. The rules derived by the SPMA 170 decision making are considered ‘current rules’ but are not necessarily ‘correct rules’. Attributes merging 174, according to the log information provided by SPMA Reason Processing 104 proceeds with the current scope of knowledge in accordance with the SPMA.

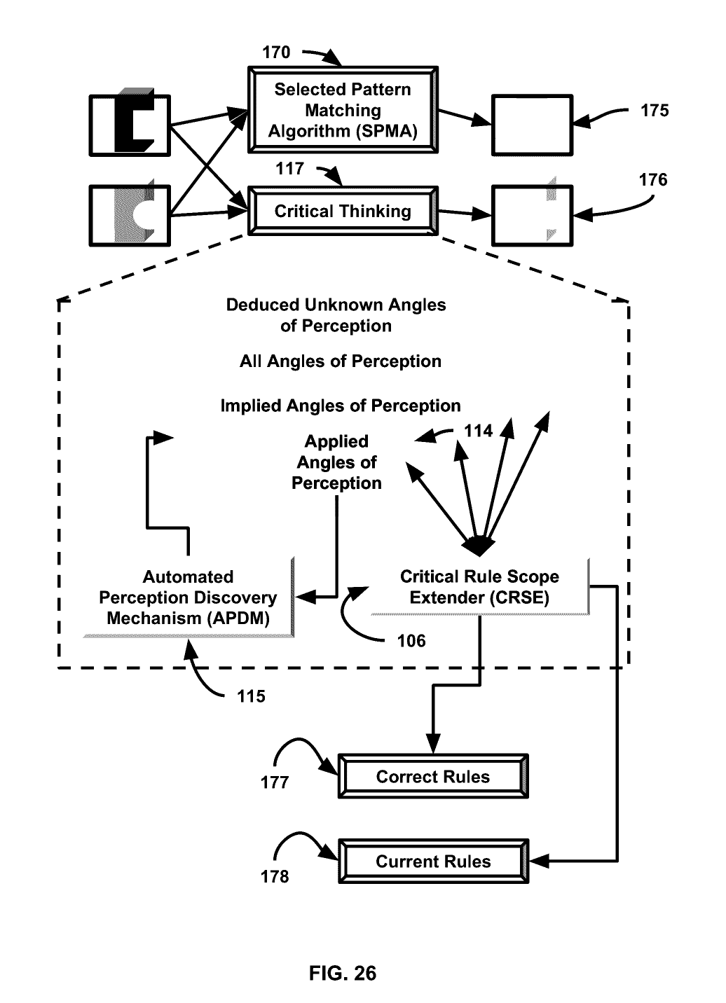

FIG. 26 shows the conventional SPMA 170 being juxtaposed against the Critical Thinking performed by CTMP via perceptions and rules. Misunderstood Action 175, The Selected Pattern Matching Algorithm (SPMA) 170 was unable to provide an entirely accurate corrective action. This is because of some fundamental underlying assumption that was not checked for in the original programming or data of the SPMA. In this example, the use of a 3D object as the input variable and the correct appropriate action illustrate that there was a dimension/vector that the SPMA did not account for. Appropriate Action 176, Critical Thinking considered the 3rd dimension, which the SPMA omitted as a vector for checking. The 3rd dimension was considered by Critical Thinking because of all the extra angles of perception checks that were performed. Referring to Correct Rules 177, the Critical Rule Scope Extender (CRSE) extends the scope of comprehension of the rulesets by leveraging previously unconsidered angles of perception (i.e., 3rd dimension). Referring to Current Rules 178, the derived rules of the current corrective action decision reflect the understanding, or lack thereof (as compared to the correct rules), of the SPMA. Input rules have been derived from the Selected Pattern Matching Algorithm (SPMA) which describe the default scope of comprehension afforded by the SPMA. This is illustrated by the SPMA comprehending only 2 dimensions in a flat plane concept of financial allocations.

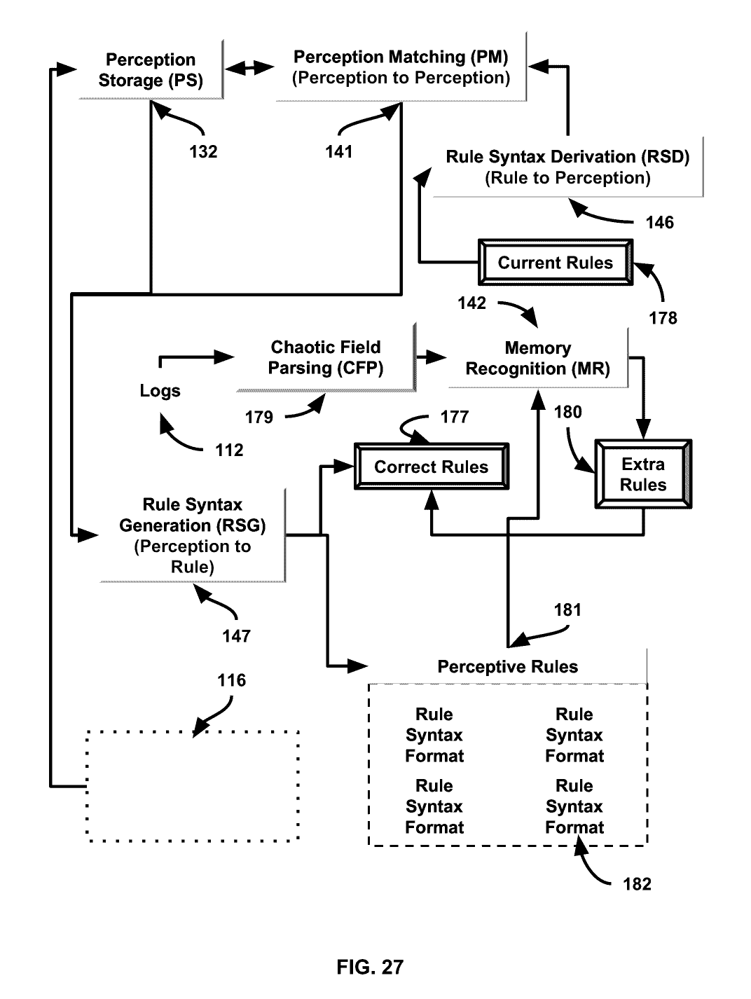

FIG. 27 shows how Correct Rules 177 are produced in contrast with the conventional Current Rules which may have omitted a significant insight and/or variable. Chaotic Field Parsing (CFP) 179, The format of the logs are combined into a single scannable unit known as the chaotic field. Extra Rules 180 are produced from Memory Recognition (MR) to supplement the already established Correct Rules Referring to Perceptive Rules 181, perceptions that are considered relevant and popular have been converted into logical rules. If a perception (in it's original perception format) had many complex metric relationships that defined many ‘grey areas’, the ‘black and white’ logical rules encompass such ‘grey’ areas by n^{th} degree expansion of complexity. [00] Rule Syntax Format 182 is a storage format that has been optimized for efficient storage and querying of variables.

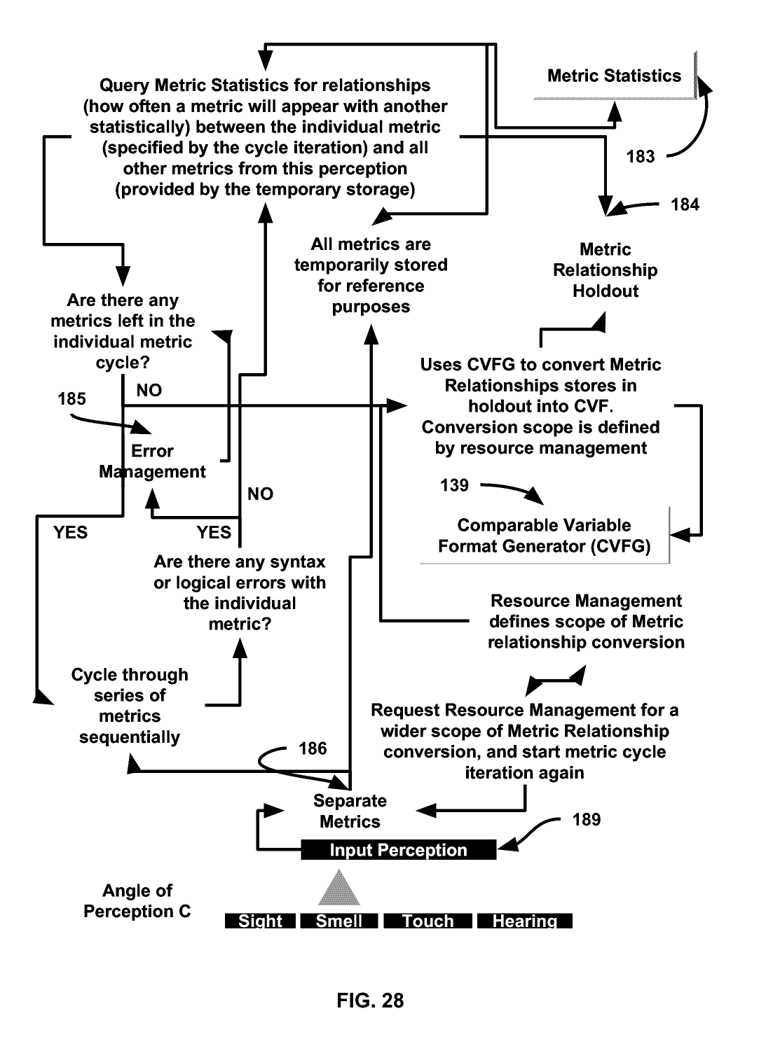

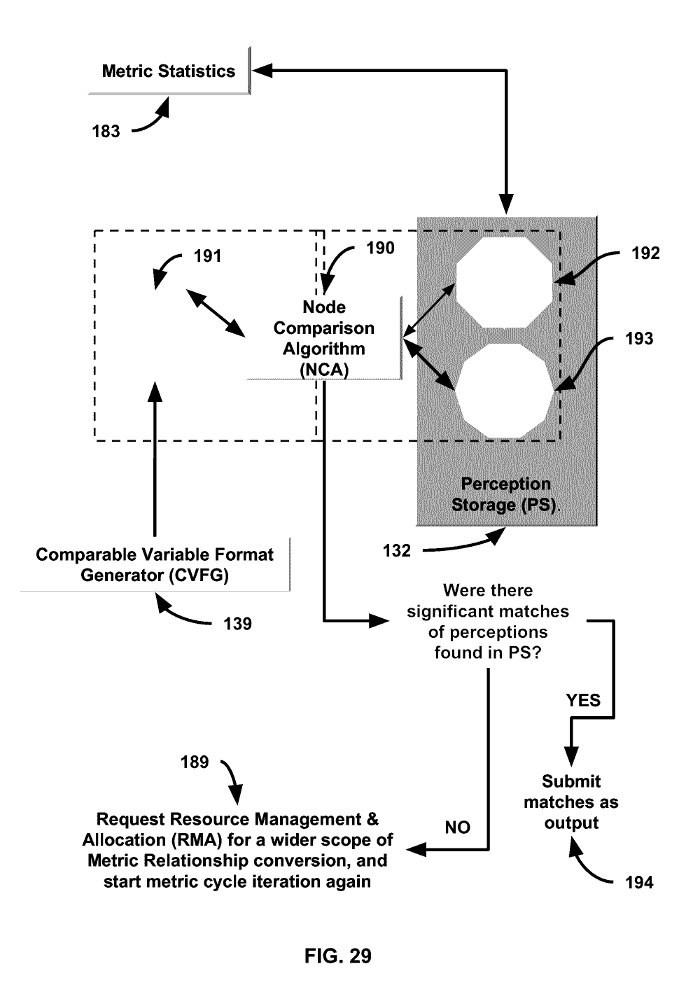

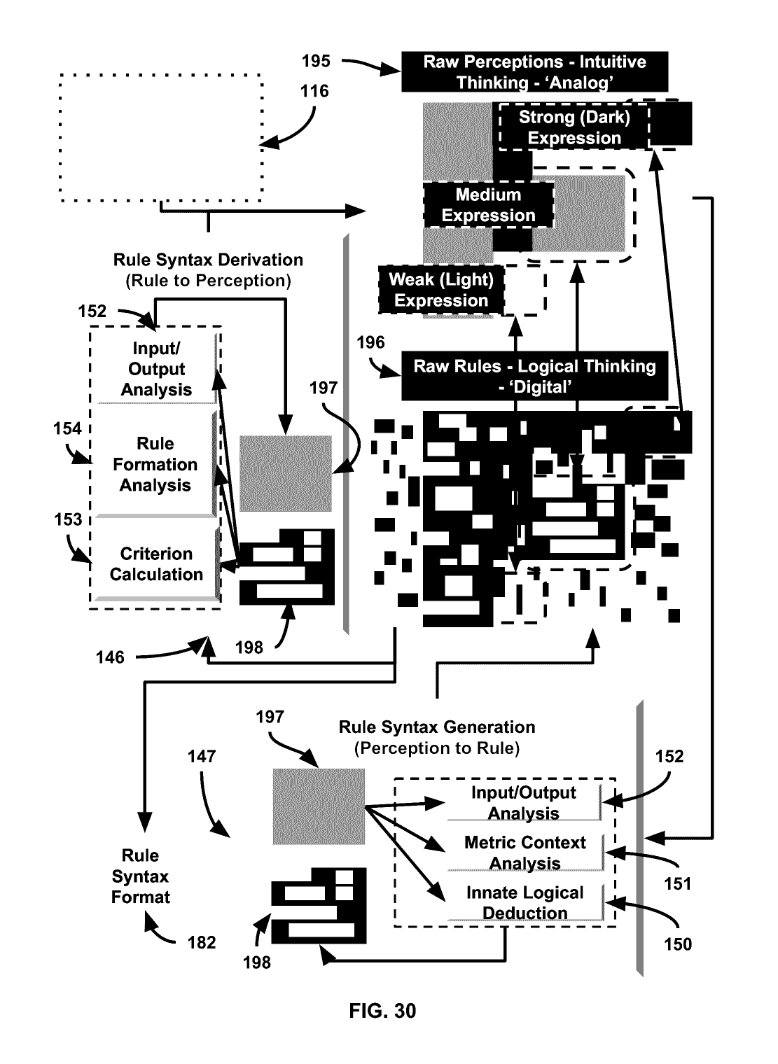

FIGS. 28-30 describe the Perception Matching (PM) 141 module. Concerning Metric Statistics 183, statistical information is provided from Perception Storage (PS). Such statistics define the popularity trends of metrics, internal metric relationships, and metric growth rate etc. Some general statistic queries (like overall Metric popularity ranking) are automatically executed and stored. Other more specific queries (how related are Metrics X and Y) are requested from PS on a realtime basis. Metric Relationship Holdout 184 holds Metric Relationship data so that it can be pushed in a unified output. Error Management 185, parses syntax and/or logical errors stemming from any of the individual metrics. Separate Metrics 186 isolates each individual metric since they used to be combined in a single unit which was the Input Perception 189. Input Perception 189 is an example composition of a perception which is made up of the metrics Sight, Smell, Touch and Hearing. Node Comparison Algorithm (NCA) 190, This module receives the node makeup of two or more CVFs. Each node of a CVF represents the degree of magnitude of a property. A similarity comparison is performed on an individual node basis, and the aggregate variance is calculated. This ensures an efficiently calculated accurate comparison. A smaller variance number, whether it be node-specific or the aggregate weight, represents a closer match. Comparable Variable Formats (CVFs) 191, 192, 193 are visual representations to illustrate the various makeups a CVF Submit matches as output 194 is the terminal output for Perception Matching (PM). Whatever nodes overlap in Node Comparison Algorithm (NCA) 190 is retained as a matching result, and hence the overall result is submitted here.

FIG. 30 shows Rule Syntax Derivation/Generation. Raw Perceptions Intuitive Thinking (Analog) 195 is where the perceptions are processed according to an ‘analog’ format. Raw Rules Logical Thinking (Digital) 196 is where rules are processed according to a digital format. Analog Format 197 perceptions pertaining to the financial allocation decision are stored in gradients on a smooth curve without steps. Digital Format 198 raw rules pertaining to the financial allocation decision are stored in steps with little to no ‘grey area’.

The present invention is explained again with regard to the claims.

The present invention provides a system of perpetual giving. The system has a memory that stores programmed instructions, a processor that is coupled to the memory and executes the programmed instructions and at least one database. Referring to FIGS. 1-5, the programmed instructions are related to the following components: a) one or more donor entities 1; b) one or more endowment fund entities 2, wherein the donor entities invest to the endowment fund entities and the endowment fund entities return profit to the donor entities, wherein tax write-off 15 is applied between tax paid by the donor entities and investment by the donor entities to the endowment fund entities; c) one or more business entities 3, wherein the endowment fund entities invest to the business entities and the business entities return profit to the endowment fund entities; d) a control board 4; and e) an investment allocator 17 that makes investment recommendation to the control board, wherein the control board provides investment preferences to the investment allocator. The investment allocator comprises a pattern matching module 25 and a static variables module 27. The donor entity, the endowment fund entity, the business entity and the control board are computer renderings that correspond to corporations or institutions in society. The computer rendered entities may communicate to and from human beings that work for the corporations, etc. via input devices and output devices and over the communication networks such as the Internet.

The system further comprises a profit allocator 22 that makes recommendation regarding reinvestment fund for the business entities and delegated fund for the control board. The profit allocator comprises a pattern matching module 25 and a static variables module 27.

Data for market performance 30 and profit history 31 are delivered for the pattern matching module of the investment allocator. Data for the business entity profit composition 32 is delivered to the profit allocator.

Referring to FIG. 8, in the pattern matching module, profit and/or investment allocation decisions are stored, and a creativity module 40 uses the stored decision, the profit history, the market performance, the static variables in the static variables module 27, or static criteria 43 provided by the control board to create new variations of allocation decisions.

Referring to FIG. 9, the system further comprises a portfolio designer 45 that designs an investment portfolio. In the portfolio designer, investment amount, charitable causes and desired risk, long term allocation trend from the stored allocation decisions, and/or profit trend from a profit margin makeup module 32 are input to a creativity module 40.

Referring to FIGS. 10 and 11, the system further comprises a tax code interpreter 51 that comprises a find overlap module 52, which performs calculated overlap search between two or more tax codes 53, 54; and a generic tax unit 59 that stores tax law information. The generic tax unit comprises an initial definition update module 60 and a preliminary conversion module 61 that converts tax law information into a raw structure 62 that comprises a dependency tree 63 and unit definitions 64. The dependency tree contains links of object dependencies, wherein the unit definitions contains names, descriptions and definitions of tax related objects.

The generic tax unit further comprises a parallelized computer processing system 66 that receives the raw structure as part of a definition update and performs scalable and parallel data mining process to calculate data sets to compose a derived structure 68.

The derived structure comprises a derived tree 69 that contains data that have been implied from the originals of the raw structure, a unit definitions 70 that contain labels associated with the objects referenced by the derived tree, derived rules 72 that are inherited by the derived tree, wherein the derived structure deduces points of interest with generic popularity algorithm.

Referring to FIG. 12, in response to simple information queries 77, the raw structure 62 of a first tax code 53 and the raw structure 62 of a second code 54 are compared. In response to complex information queries, the derived structure 68 of the first tax code and the derived structure 68 of the second tax code are compared. A focus points analysis 80 synchronizes the points of interests 71 of the first tax code and the points of interests of the second tax code. Results from the focus points analysis are sent to the derived trees of the first tax code and the second tax code. Information from the derived trees are matched with their respective definitions from the unit definitions 64.

Referring to FIGS. 13-17, the creativity module 40 references two or more prior allocation decisions 83. Each of the allocation decisions comprises a market context 84, an investor context 85, and a final result 86. The allocation decisions are provided to an intelligent selector 87, which performs comparison and deduction of two objects from each of the allocation decisions and pushes a hybrid form for output. A criteria matching module 91 references input criteria provided from the pattern matching modules and chooses the hybrid form from the intelligent selector, which suits the market variables.

The prior allocation decisions comprise an average model of a financial allocation decision derived from a prior allocation decisions database and a new information released by the allocators. The intelligent selector 94 merges them into the hybrid form. A mode 95 defines type of algorithm that the creativity module is being used in. Amount of overlapping information is filtered through according to a ratio set by the static criteria 96, which include ranking prioritizations, desired ratios of data, and data to direct merging which is dependent on what Mode is selected. A raw comparison 97 is performed on the prior allocation decisions dependent on the static criteria.

When both data sets compete to define a feature at the same place in the form, a prioritization process 100 occurs to produce a form with merged traits based on the static criteria and the mode.

Referring to FIG. 18, an input module 103 receives result by the pattern matching and the allocation decision. A reason processing module 104 compares attributes of the received inputs and derives rules. The reason processing module comprises a rule processing module 105 that uses the derived rules as reference point to determine the scope of perceptions for a given problem. A critical rule scope extender 106 receives the known scope of perceptions and upgrades them to include critical thinking scope of perceptions. The derived rules are corrected by using the critical thinking scope of perceptions.

A memory web 108 scans logs for fulfillable rules. Applicable and fulfillable rules are executed to produce override decisions. A rule execution module 109 executes rules that have been confirmed as present and fulfilled to produce critical thinking decisions. A critical decision output module 110 produces final logic by comparing conclusions reached by a perception observer emulator 119 (FIG. 19) and the rule execution module.

A logs module 112 comprises raw information that is used to make a critical decision without influence of the input. An applied angles of perception module 114 comprises angles of perception that have been applied and utilized by the input algorithm. An automated perception discovery mechanism 115 leverages the creativity module to increase the scope of perception.

Referring to FIG. 19, a self-critical knowledge density module 118 estimates scope and type of potential unknown knowledge that is beyond the reach of the reportable logs. The perception observer emulator produces emulation of observer, and tests and/or compares all potential points of perception with variations of observer emulations. Input for the perception observer emulator comprises all the potential points of perception and enhanced data logs and output for the perception observer emulator comprises decision produced from the enhanced data logs and according to the most relevant observer with mixture of selected perceptions. The CVF derived from the data enhanced logs is used as search criteria for a perception storage. An implication derivation module 120 derives angles of perception of data that are implicated from known angles of perceptions. Referring to FIG. 21, a metric combination module 136 separates angles of perception into categories of metrics. A metric conversion module 137 reverses individual metrics back into whole angles of perception. A metric expansion module 138 categorically stores the metrics of angles of perception in individual databases.

Referring to FIG. 21, a critical rule scope extender 140 leverages known perceptions to expand critical thinking scope of rulesets. A perception matching module 141 forms CVF from the perception received from rule syntax derivation 146. A memory recognition module 142 forms a chaotic field from input data and performs field scanning to recognize known concepts. A memory concept indexing module 143 individually optimizes the whole concepts into indexes. A rule fulfillment parser 144 receives the individual parts of the rule with a tag of recognition, logically deduces which rules have been recognized in the chaotic field to merit rule execution. A rule syntax format separation module 148 separates and organizes correct rules by type. A rule syntax derivation module 146 converts logical rules to metric based perceptions. A rule syntax generation module 147 receives confirmed perceptions and engages with the perception's internal metric makeup.

Referring to FIGS. 22-27, a final logic module receives intelligent information from an intuitive decision 158 and a thinking decision 159. A direct decision comparison module 156 compares both decisions from the intuitive decision and the thinking decision to check for corroboration. The intuitive decision engages in critical thinking via leveraging perceptions. The thinking decision engages in critical thinking via leveraging rules. A critical rule scope extender 140 extends the scope of comprehension of the rulesets by leveraging previously unconsidered angles of perception. A chaotic field parsing module 179 combines the format of the logs into a single scannable unit known as the chaotic field. Extra rules are produced from a memory recognition module 142 to supplement the already established correct rules.

Referring to FIGS. 28-30, in a perception matching module 141, concerning metric statistics, statistical information is provided from a perception storage 132. The statistics define the popularity trends of metrics, internal metric relationships, and metric growth rate. An error management module 185 parses syntax and/or logical errors stemming from any of the individual metrics. A node comparison module 190 receives the node makeup of two or more CVFs. Each node of the CVF represents the degree of magnitude of a property. A similarity comparison is performed on an individual node basis, and the aggregate variance is calculated. A raw perceptions intuitive thinking module 195 processes the perceptions according to an analog format. A raw rules logical thinking module 196 processes rules according to a digital format. Analog format perceptions pertaining to the financial allocation decision are stored in gradients on a smooth curve without steps. Digital format raw rules pertaining to the financial allocation decision are stored in steps with no grey area.

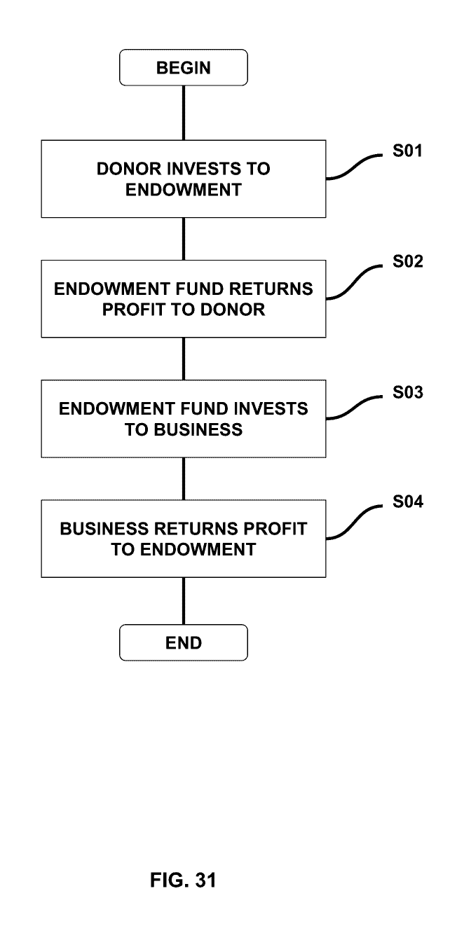

FIG. 31 shows a method of perpetual giving performed in a system having a memory that stores programmed instructions, a processor that is coupled to the memory and executes the programmed instructions and at least one database. The method comprises step S01 of investing to one or more endowment fund entities by one or more donor entities; S02 of returning profit to the donor entities by the endowment fund entities, wherein tax write-off is applied between tax paid by the donor entities and investment by the donor entities to the endowment fund entities; S03 of investing to one or more business entities by the endowment fund entities; and S04 of returning profit to the endowment fund entities by the business entities. An investment allocator makes investment recommendation to a control board. The control board provides investment preferences to the investment allocator. A profit allocator makes recommendation regarding reinvestment fund for the business entities and delegated fund for the control board. Each of the allocators include a creativity module and a CTMP module.

1. A system of perpetual giving, wherein the system having a memory that stores programmed instructions, a processor that is coupled to the memory and executes the programmed instructions and at least one database, wherein the system comprising:
a) one or more donor entities;
b) one or more endowment fund entities, wherein the donor entities invest to the endowment fund entities and the endowment fund entities return profit to the donor entities, wherein tax write-off is applied between tax paid by the donor entities and investment by the donor entities to the endowment fund entities;
c) one or more business entities, wherein the endowment fund entities invest to the business entities and the business entities return profit to the endowment fund entities;
d) a control board; and
e) an investment allocator that makes investment recommendation to the control board, wherein the control board provides investment preferences to the investment allocator;
wherein the investment allocator comprises a pattern matching module and a static variables module.

2. The system of claim 1, further comprising a profit allocator that makes recommendation regarding reinvestment fund for the business entities and delegated fund for the control board, wherein the profit allocator comprises a pattern matching module and a static variables module.

3. The system of claim 2, wherein data for market performance and profit history are delivered for the pattern matching module of the investment allocator, wherein data for the business entity profit composition is delivered to the profit allocator.

4. The system of claim 3, wherein in the pattern matching module, profit and/or investment allocation decisions are stored, and a creativity module uses the stored decision, the profit history, the market performance, the static variables in the static variables module, or static criteria provided by the control board to create new variations of allocation decisions.

5. The system of claim 4, further comprising a portfolio designer that designs an investment portfolio, wherein in the portfolio designer, investment amount, charitable causes and desired risk, long term allocation trend from the stored allocation decisions, and/or profit trend from a profit margin makeup module are input to a creativity module.

6. The system of claim 2, further comprising a tax code interpreter that comprises a find overlap module, which performs calculated overlap search between two or more tax codes; and a generic tax unit that stores tax law information;
wherein the generic tax unit comprises an initial definition update module and a preliminary conversion module that converts tax law information into a raw structure that comprises a dependency tree and unit definitions, wherein the dependency tree contains links of object dependencies, wherein the unit definitions contains names, descriptions and definitions of tax related objects.

7. The system of claim 6, wherein the generic tax unit further comprises a parallelized computer processing system that receives the raw structure as part of a definition update and performs scalable and parallel data mining process to calculate data sets to compose a derived structure.

8. The system of claim 7, wherein the derived structure comprises a derived tree that contains data that have been implied from the originals of the raw structure, a unit definitions that contain labels associated with the objects referenced by the derived tree, derived rules that are inherited by the derived tree, wherein the derived structure deduces points of interest with generic popularity algorithm.

9. The system of claim 8, wherein in response to simple information queries, the raw structure of a first tax code and the raw structure of a second code are compared, wherein in response to complex information queries, the derived structure of the first tax code and the derived structure of the second tax code are compared, wherein a focus points analysis synchronizes the points of interests of the first tax code and the points of interests of the second tax code, wherein results from the focus points analysis are sent to the derived trees of the first tax code and the second tax code, wherein information from the derived trees are matched with their respective definitions from the unit definitions.

10. The system of claim 5, wherein the creativity module references two or more prior allocation decisions, wherein each of the allocation decisions comprises a market context, an investor context, and a final result, wherein the allocation decisions are provided to an intelligent selector, which performs comparison and deduction of two objects from each of the allocation decisions and pushes a hybrid form for output, wherein a criteria matching references input criteria provided from the pattern matching modules and chooses the hybrid form from the intelligent selector, which suits the market variables.

11. The system of claim 10, wherein the prior allocation decisions comprise an average model of a financial allocation decision derived from a prior allocation decisions database and a new information released by the allocators, wherein the intelligent selector merges them into the hybrid form, wherein a mode defines type of algorithm that the creativity module is being used in, wherein amount of overlapping information is filtered through according to a ratio set by the static criteria, which include ranking prioritizations, desired ratios of data, and data to direct merging which is dependent on what Mode is selected, wherein a raw comparison is performed on the prior allocation decisions dependent on the static criteria.

12. The system of claim 11, wherein when both data sets compete to define a feature at the same place in the form, a prioritization process occurs to produce a form with merged traits based on the static criteria and the mode.

13. The system of claim 5, wherein an input module receives result by the pattern matching and the allocation decision, wherein a reason processing module compares attributes of the received inputs and derives rules, wherein the reason processing module comprises a rule processing module that uses the derived rules as reference point to determine the scope of perceptions for a given problem, wherein a critical rule scope extender receives the known scope of perceptions and upgrades them to include critical thinking scope of perceptions, wherein the derived rules are corrected by using the critical thinking scope of perceptions.

14. The system of claim 13, wherein a memory web scans logs for fulfillable rules, wherein applicable and fulfillable rules are executed to produce override decisions, wherein a rule execution module executes rules that have been confirmed as present and fulfilled to produce critical thinking decisions, wherein a critical decision output module produces final logic by comparing conclusions reached by a perception observer emulator and the rule execution module.

15. The system of claim 14, wherein a logs module comprises raw information that is used to make a critical decision without influence of the input, wherein an applied angles of perception module comprises angles of perception that have been applied and utilized by the input algorithm, an automated perception discovery mechanism leverages the creativity module to increase the scope of perception.

16. The system of claim 15, wherein a self-critical knowledge density module estimates scope and type of potential unknown knowledge that is beyond the reach of the reportable logs, wherein the perception observer emulator produces emulation of observer, and tests and/or compares all potential points of perception with variations of observer emulations, wherein input for the perception observer emulator comprises all the potential points of perception and enhanced data logs and output for the perception observer emulator comprises decision produced from the enhanced data logs and according to the most relevant observer with mixture of selected perceptions, wherein the CVF derived from the data enhanced logs is used as search criteria for a perception storage, wherein an implication derivation module derives angles of perception of data that are implicated from known angles of perceptions, wherein a metric combination separates angles of perception into categories of metrics, wherein a metric conversion reverses individual metrics back into whole angles of perception, wherein a metric expansion categorically stores the metrics of angles of perception in individual databases.

17. The system of claim 16, wherein a critical rule scope extender leverages known perceptions to expand critical thinking scope of rulesets, wherein a perception matching forms CVF from the perception received from rule syntax derivation, wherein a memory recognition forms a chaotic field from input data and performs field scanning to recognize known concepts, wherein a memory concept indexing module individually optimizes the whole concepts into indexes, wherein a rule fulfillment parser receives the individual parts of the rule with a tag of recognition, logically deduces which rules have been recognized in the chaotic field to merit rule execution, wherein a rule syntax format separation separates and organizes correct rules by type, wherein a rule syntax derivation converts logical rules to metric based perceptions, and wherein a rule syntax generation receives confirmed perceptions and engages with the perception's internal metric makeup.

18. The system of claim 13, wherein a final logic module logic receives intelligent information from an intuitive decision and a thinking decision, wherein a direct decision comparison module compares both decisions from the intuitive decision and the thinking decision to check for corroboration, wherein the intuitive decision engages in critical thinking via leveraging perceptions, wherein the thinking decision engages in critical thinking via leveraging rules, wherein a critical rule scope extender extends the scope of comprehension of the rulesets by leveraging previously unconsidered angles of perception, wherein a chaotic field parsing module combines the format of the logs into a single scannable unit known as the chaotic field, wherein extra rules are produced from a memory recognition module to supplement the already established correct rules.

19. The system of claim 18, wherein in a perception matching module, concerning metric statistics, statistical information is provided from a perception storage, wherein the statistics define the popularity trends of metrics, internal metric relationships, and metric growth rate, wherein an error management module parses syntax and/or logical errors stemming from any of the individual metrics, wherein a node comparison module receives the node makeup of two or more CVFs, wherein each node of the CVF represents the degree of magnitude of a property, wherein a similarity comparison is performed on an individual node basis, and the aggregate variance is calculated, wherein a raw perceptions intuitive thinking module processes the perceptions according to an analog format, wherein a raw rules logical thinking module processes rules according to a digital format, wherein analog format perceptions pertaining to the financial allocation decision are stored in gradients on a smooth curve without steps, wherein digital format raw rules pertaining to the financial allocation decision are stored in steps with no grey area.

20. A method of perpetual giving performed in a system having a memory that stores programmed instructions, a processor that is coupled to the memory and executes the programmed instructions and at least one database, wherein method comprising steps of:
a) investing to one or more endowment fund entities by one or more donor entities;
b) returning profit to the donor entities by the endowment fund entities, wherein tax write-off is applied between tax paid by the donor entities and investment by the donor entities to the endowment fund entities;
c) investing to one or more business entities by the endowment fund entities; and
d) returning profit to the endowment fund entities by the business entities;
wherein an investment allocator makes investment recommendation to a control board, wherein the control board provides investment preferences to the investment allocator, wherein a profit allocator makes recommendation regarding reinvestment fund for the business entities and delegated fund for the control board, wherein each of the allocators include a creativity module and a CTMP module.
